(19) United States
(12) Patent Application Publication
(10) Pub. No.: US 2023/0278565 A1
(43) Pub. Date: Sep. 7, 2023

(54) DRIVING ASSISTANCE DEVICE

(71) Applicant: Panasonic Intellectual Property Management Co., Ltd., Osaka (JP)

(72) Inventors: Yoshimasa OKABE, Kanagawa Ken (JP); Takashi OKOHIRA, Tokyo To (JP)

(73) Assignee: Panasonic Intellectual Property Management Co., Ltd., Osaka (JP)

(21) Appl. No.: 18/105,021

(22) Filed: Feb. 2, 2023

(30) Foreign Application Priority Data
Mar. 3, 2022 (JP) 2022-032969

(51) Int. Cl. B60W 40/09; B60W 50/16; B60W 60/00; G06V 20/59; G06V 40/18

(52) U.S. Cl. CPC B60W 40/09; B60W 50/16; B60W 60/001; G06V 20/597; G06V 40/18; B60W 2540/26

(57) ABSTRACT

A driving assistance device to be mounted on a vehicle which is capable of executing automatic steering control is disclosed. The driving assistance device includes a hardware processor connected to a memory. The hardware processor monitors a state of eyes of a driver of the vehicle and an awakening state of the driver. The hardware processor controls output of a predetermined warning to the driver. The warning is output in a case where: the automatic steering control is being executed in the vehicle, the eyes of the driver are closed, and the driver is not in a predetermined awakening state. The warning is not output to the driver in a case where: the automatic steering control is being executed in the vehicle, the eyes of the driver are closed, and the driver is in the predetermined awakening state.

### CROSS-REFERENCE TO RELATED APPLICATIONS

This application is based upon and claims the benefit of priority from Japanese Patent Application No. 2022-032969, filed on Mar. 3, 2022, the entire contents of which are incorporated herein by reference.

### FIELD

The present disclosure relates generally to a driving assistance device.

### BACKGROUND

Conventionally, there is a technique for canceling autonomous driving on the basis of biological information of a driver in an autonomous driving mode (for example, JP 6182630 B2).

During driving, the driver takes in information mainly through vision to make a decision, so that a load is applied to visual pathways such as eyes, an optic nerve, and a visual field of a brain. Accumulation of fatigue in the visual pathway leads to symptoms such as eyestrain, but it is known that by closing the eyes and resting the visual pathway to soothe muscles and nerves related to the eyes, it is possible to recover from fatigue and improve the symptoms.

However, when the driver closes his/her eyes to recover eye fatigue, the driver is determined to fall asleep, and thereby the autonomous driving is canceled. Therefore, it is difficult for the driver to recover the fatigue.

### SUMMARY

A driving assistance device according to the present disclosure is a driving assistance device to be mounted on a vehicle which is capable of executing automatic steering control. The driving assistance device includes a hardware processor connected to a memory. The hardware processor is configured to monitor a state of eyes of a driver of the vehicle and an awakening state of the driver. The hardware processor is configured to output a predetermined warning to the driver in a case where: the automatic steering control is being executed in the vehicle, the eyes of the driver are closed, and the driver is not in a predetermined awakening state. The hardware processor is configured to output none of the predetermined warning to the driver in a case where: the automatic steering control is being executed in the vehicle, the eyes of the driver are closed, and the driver is in the predetermined awakening state.

### BRIEF DESCRIPTION OF THE DRAWINGS

FIG. 1 is a diagram illustrating an example of a vehicle including a driving assistance device according to an embodiment;

FIG. 2 is a block diagram illustrating an example of a configuration of the driving assistance device according to the embodiment;

FIG. 3 is a timing chart illustrating an example of a flow of driving assistance processing according to the embodiment;

FIG. 4 is a timing chart illustrating an example of a flow of driving assistance processing according to the embodiment;

FIG. 5 is a diagram illustrating an example of a hardware configuration of the driving assistance device according to the embodiment;

FIG. 6 is a flowchart illustrating an example of a flow of driving assistance processing according to the embodiment; and

FIG. 7 is a flowchart illustrating an example of a flow of driving assistance processing according to the embodiment.

### DETAILED DESCRIPTION

Hereinafter, embodiments of a driving assistance device according to the present disclosure will be described with reference to the drawings.

It is assumed that the vehicle according to the present embodiment is capable of autonomous driving on an expressway, and the driver is not obliged to gaze forward during the autonomous driving. It is basically the case that the vehicle has functions for automatically overtaking, changing lanes, and branching during autonomous driving, but the case where autonomous driving is possible only when maintaining the lane will also be explained.

A driving assistance device 100 according to the present embodiment is a device that can be mounted on a vehicle capable of executing automatic steering control. In the present embodiment, an embodiment will be described in which the driving assistance device 100 is implemented in autonomous driving implemented on an expressway, for example.

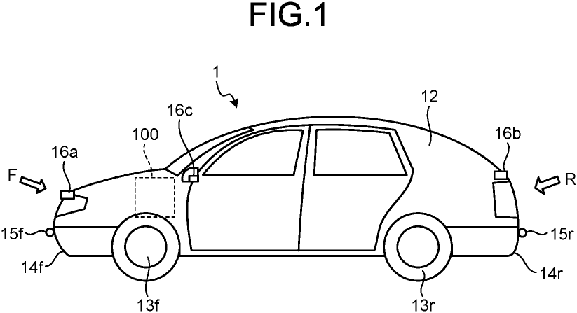

FIG. 1 is a diagram illustrating an example of a vehicle 1 including the driving assistance device 100 according to the present embodiment. As illustrated in FIG. 1, the vehicle 1 includes a vehicle body 12 and two pairs of wheels 13 disposed along a predetermined direction on the vehicle body 12. The two pairs of wheels 13 include a pair of front tires 13f and a pair of rear tires 13r.

The front tires 13f illustrated in FIG. 1 are an example of a first wheel in the present embodiment. Moreover, the rear tires 13r are an example of a second wheel in the present embodiment. Note that the vehicle 1 illustrated in FIG. 1 includes four wheels 13, whereas the number of wheels 13 is not limited thereto. For example, the vehicle 1 may be a two-wheeled vehicle.

The vehicle body 12 is coupled with the wheels 13 and is movable by the wheels 13. In this case, a direction in which the pair of front tires 13f faces is a traveling direction (moving direction) of the vehicle 1. The vehicle 1 can move forward or backward by switching gears (not illustrated) or the like. Moreover, the vehicle 1 can also turn right or left by steering.

Moreover, the vehicle body 12 includes a front end part F that is an end part on a side of the front tires 13f and a rear end part R that is an end part on a side of the rear tires 13r. The vehicle body 12 has a substantially rectangular shape in top view, and four corners of the substantially rectangular shape may be referred to as end parts. Moreover, although not illustrated in FIG. 1, the vehicle 1 includes a display, a speaker, and an operation unit.

A pair of bumpers 14 is provided near a lower end of the vehicle body 12 in the front end part F and the rear end part R of the vehicle body 12. Among the pair of bumpers 14, a front bumper 14f covers an entire front surface and a part of a side surface in the vicinity of the lower end part of the vehicle body 12. Of the pair of bumpers 14, a rear bumper 14r covers the entire rear surface and a part of the side surface in the vicinity of the lower end part of the vehicle body 12.

A transmitter/receiver 15f and a transmitter/receiver 15r that transmit and receive a sound wave such as an ultrasonic wave are disposed at a predetermined end part of the vehicle body 12. For example, one or more transmitters/receivers 15f are disposed on the front bumper 14f, and one or more transmitters/receivers 15r are disposed on the rear bumper 14r. Hereinafter, in a case where the transmitters/receivers 15f and 15r are not particularly limited, they are simply referred to as a transmitter/receiver 15. Moreover, the number and positions of the transmitters/receivers 15 are not limited to the example illustrated in FIG. 1. For example, the vehicle 1 may include the transmitter/receiver 15 on the left and right sides.

In the present embodiment, sonar using ultrasonic waves will be described as an example of the transmitter/receiver 15, but the transmitter/receiver 15 may be a radar that transmits and receives electromagnetic waves. Alternatively, the vehicle 1 may include both a sonar and a radar. Moreover, the transmitter/receiver 15 may be simply referred to as a sensor.

More specifically, the transmitter/receiver 15 includes a transmitter that transmits a sound wave such as an ultrasonic wave or an electromagnetic wave, and a receiver that receives a reflected sound wave in which the sound wave or the electromagnetic wave transmitted from the transmitter is reflected by an object. Moreover, a result of transmission and reception of a sound wave or an electromagnetic wave by the transmitter/receiver is used for detection of an object around the vehicle 1 and measurement of a distance between the object and the vehicle 1 by a distance measuring device to be described later. The distance measuring device is not illustrated in FIG. 1.

Moreover, the vehicle 1 includes a first imaging device 16a that images the front of the vehicle 1, a second imaging device 16b that images the rear of the vehicle 1, a third imaging device 16c that images the left side of the vehicle 1, and a fourth imaging device that images the right side of the vehicle 1. The fourth imaging device is not illustrated in FIG. 1.

Hereinafter, the first imaging device 16a, the second imaging device 16b, the third imaging device 16c, and the fourth imaging device will be simply referred to as an external imaging device 16 unless otherwise distinguished. Moreover, in the present embodiment, the vehicle 1 only needs to include at least the third imaging device 16c and the fourth imaging device, and the first imaging device 16a and the second imaging device 16b are not essential. Moreover, the vehicle 1 may further include another imaging device in addition to the above-described example. Moreover, in the present embodiment, the external imaging device 16 may be included in the sensor.

The external imaging device 16 can capture a video around the vehicle 1, and is, for example, a camera that captures a color image. Note that a captured image captured by the external imaging device 16 may be a moving image or a still image. Moreover, the external imaging device 16 may be a camera built in the vehicle 1, a camera of a drive recorder retrofitted to the vehicle 1, or the like.

In the present embodiment, the transmitter/receiver 15 and the external imaging device 16 are an example of a detection device capable of detecting a surrounding state. Note that only the transmitter/receiver 15 may be an example of the detection device, or only the external imaging device 16 may be an example of the detection device.

Moreover, the driving assistance device 100 is mounted on the vehicle 1. The driving assistance device 100 is an information processing device that can be mounted on the vehicle 1, and is, for example, an electronic control unit (ECU) or an on board unit (OBU) provided inside the vehicle 1. Alternatively, the driving assistance device 100 may be an external device installed near a dashboard of the vehicle 1. A hardware configuration of the driving assistance device 100 will be described later. Note that the driving assistance device 100 may also serve as a car navigation device or the like.

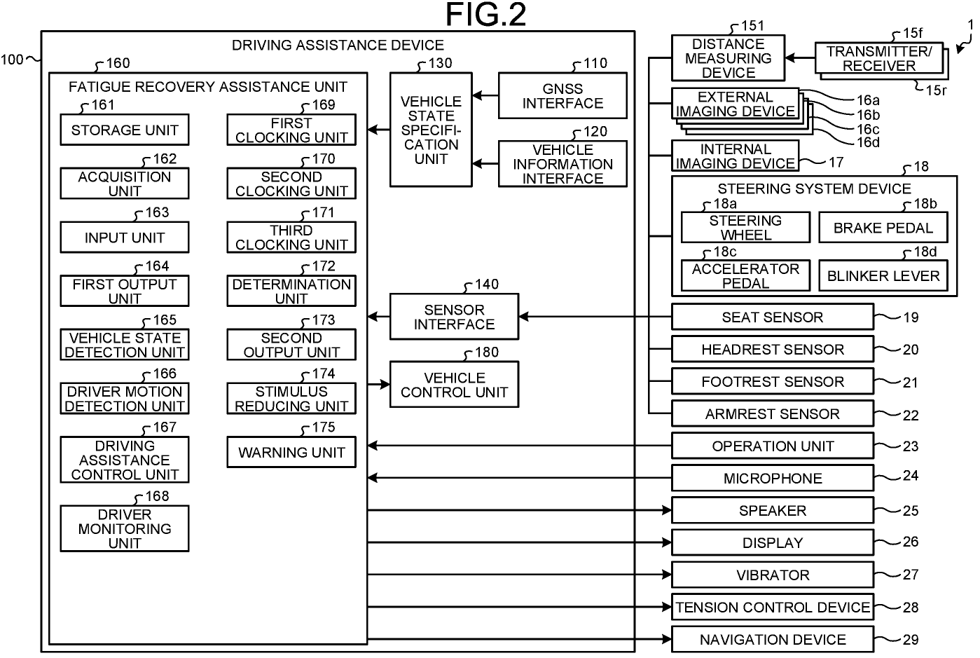

FIG. 2 is a block diagram illustrating an example of a configuration of the driving assistance device 100 according to a first embodiment. As illustrated in FIG. 2, the driving assistance device 100 includes a global navigation satellite system (GNSS) interface 110, a vehicle information interface 120, a vehicle state specification unit 130, a sensor interface 140, a fatigue recovery assistance unit 160, and a vehicle control unit 180.

Moreover, the vehicle 1 also includes an internal imaging device 17, a steering system device 18, a seat sensor 19, a headrest sensor 20, a footrest sensor 21, an armrest sensor 22, an operation unit 23, a microphone 24, a speaker 25, a display 26, a vibrator 27, a tension control device 28, and a navigation device 29. Note that FIG. 2 illustrates a functional mutual relationship, and does not illustrate a physical inclusion relationship. For example, the GNSS interface 110 functionally has a function of a GPS reception module (also referred to as a GPS module), and may be physically a circuit built in the navigation device 29.

The internal imaging device 17 is an imaging device provided inside the vehicle. Specifically, the internal imaging device 17 is an imaging device intended to image the driver. The internal imaging device 17 is, for example, an imaging device provided with a lens facing the driver from the vicinity of a dashboard or a rearview mirror in front of a driver’s seat provided in the vehicle 1 so as to capture the driver in the visual field. The internal imaging device 17 images a state (as an example, a driving operation of the driver and an operation of the face including the eyes, the mouth, the eyelids, and the like of the driver) of the driver in the vehicle 1. Note that the captured image captured by the internal imaging device 17 may be a moving image or a still image.

The steering system device 18 is a device for steering the vehicle 1. The steering system device 18 includes, for example, a steering wheel 18a, a brake pedal 18b, an accelerator pedal 18c, and a blinker lever 18d. The steering wheel 18a is a steering wheel for steering the vehicle 1 installed on a dashboard in front of the driver’s seat provided in the vehicle. The brake pedal 18b is a device for braking the vehicle 1, and is, for example, a device for suppressing the rotation of the wheels 13 provided in the vehicle 1 by the driver stepping on the brake pedal 18b.

The accelerator pedal 18c is a device for accelerating and decelerating the vehicle 1. For example, the accelerator pedal 18c is a device that controls the rotation speed of an engine provided in the vehicle 1 by the driver stepping on the accelerator pedal 18c. The blinker lever 18d is a device that receives a lever operation by the driver and turns on a direction indicator (not illustrated) of the vehicle 1.

The seat sensor 19 is a pressure-sensitive sensor provided in a seat on which the driver sits. The seat sensor 19 may be said to be a device that detects a state of the driver’s driving posture. Note that the seat sensor 19 may be provided in a seat bag that leans the back of the driver. The headrest sensor 20 is a pressure-sensitive sensor provided in a headrest on which the driver’s head leans. The headrest sensor 20 is a device that detects a state in which the head of the driver leans. A combination of the headrest sensor 20 and the seat sensor 19 may be referred to as a device that detects the state of the driver’s driving posture.

The footrest sensor 21 is a pressure-sensitive sensor provided on a footrest that is located near the brake pedal 18b, places a foot of the driver, and relieves the driver’s posture. The footrest sensor 21 is a device that detects a state in which a foot of the driver is placed. The armrest sensor 22 is a sensor provided on a driver’s seat and provided on an armrest on which an arm of the driver is placed. The armrest sensor 22 is a device that detects a state in which an arm of the driver is placed.

The operation unit 23 is a button, a touch panel, or the like that can be operated by a user such as a driver or a passenger. The microphone 24 is a device that collects a voice uttered by a user such as a driver or a passenger. The speaker 25 is a device that notifies the driver of a message by voice or outputs a warning sound.

The display 26 is provided at a position visually recognizable by the driver, and is a device that can confirm a vehicle state of the vehicle 1, for example. The display 26 is a liquid crystal display, an organic electro-luminescence (EL) display, or the like. Note that the display 26 may be a display unit of a car navigation device mounted on the vehicle 1.

The vibrator 27 is a device provided on the steering wheel 18a, a seat, an armrest, a footrest, a pedal, a headrest, and the like. The vibrator 27 is a device that applies a vibration stimulus to the driver. For the pedal, a vibration stimulus may be applied to the driver by varying a reaction force.

The tension control device 28 is a device that controls the tension of the seat belt. The tension control device 28 is, for example, a device that loosens the tension of the seat belt to reduce stimulation, or increases a force received by the driver from the seat belt to stimulate the driver. The tension control device 28 may apply a vibration stimulus to the driver by varying the tension, or may include the vibration stimulus in the vibrator 27.

The navigation device 29 is a device including a memory not illustrated that stores map information and a unit for acquiring position information of the vehicle 1, and the latter is, for example, a device including the global navigation satellite system (GNSS) interface 110. Moreover, the navigation device 29 further includes a user interface device that inputs destination information and a target arrival time, and includes a touch panel in many examples. The touch panel of the navigation device 29 often also serves as the display 26 that displays the vehicle state and the operation unit 23 that gives an instruction to the driving assistance device 100, and some functions in conjunction with the driving assistance function.

For example, in the case of the vehicle 1 that supports autonomous driving, when a distant destination is set by the navigation device 29, a route using a highway is proposed, and when the proposal is approved, a navigation guide by voice and image is started. The driver manually travels according to the guide of the navigation device 29 and enters the highway, and when the driver instructs the navigation device 29 to perform the autonomous driving at a timing when the autonomous driving becomes possible, a driving assistance control unit 167 to be described later mainly takes over the driving of the vehicle.

Specifically, the driving assistance control unit 167 collates the position information of the host vehicle acquired by the GPS with the map information stored in the navigation device 29, specifies the current position on the map, changes the lane in accordance with a direction of the divergence when approaching a branch point for reaching the destination, and performs steering in accordance with the shape of the divergence at the branch point. At this time, in a case where the driving assistance function does not support the function of automatically performing the lane change or the branching, the autonomous driving may be canceled before a point where the branching is necessary, and the driver may manually perform the branching according to the guide of the navigation device 29.

Note that a user interface unit between the driver and the driving assistance device 100 is not limited to the touch panel of the navigation device 29. For example, the driver may instruct the driving assistance device 100 to perform the autonomous driving by utterance of a predetermined keyword such as “start the autonomous driving” (voice command), and the navigation device 29 may guide the driver by outputting a voice message such as “start the manual driving because the leftward branch is necessary” from the speaker 25.

The GNSS interface 110 acquires, for example, position information (GNSS coordinates) based on a global positioning system (GPS) signal received from a GPS satellite by a GPS module (not illustrated) mounted on the vehicle 1. Since the satellite used by the GNSS is not limited to a so-called GPS satellite, it can be said that the GPS module is an example of a device included in the GNSS interface 110. Note that, in the present embodiment, the GNSS coordinates are given as an example of the position information of the vehicle 1, but the position of the vehicle 1 may be specified by a method other than GNSS.

The vehicle information interface 120 is an interface for acquiring information on a traveling state of the vehicle 1. The information regarding the traveling state of the vehicle 1 is, for example, position information of the vehicle 1, a type of road on which the vehicle 1 is traveling (By way of example, whether it is a highway or a general road.), speed, a steering angle, acceleration, and the like. For example, the vehicle information interface 120 acquires information such as speed, a steering angle, and acceleration regarding the traveling state of the vehicle 1 from another ECU or various sensors of the vehicle 1 via a controller area network (CAN) or a local area network (LAN).

Moreover, the position information, the type of road on which the vehicle is traveling (hereinafter, also referred to as a road type), and the like may be acquired by the navigation device 29 or an in-vehicle electronic toll collection system (ETC) device (not illustrated).

The vehicle state specification unit 130 specifies the traveling state of the vehicle 1 on the basis of the position information, the road type, the speed, the steering angle, the acceleration, and the like of the vehicle 1 acquired from the GNSS interface 110 and the vehicle information interface 120. The traveling state of the vehicle 1 includes, for example, the position and speed of the vehicle 1. The vehicle state specification unit 130 may specify the position of the vehicle 1 with high accuracy by correcting the position information on the basis of the GPS signal based on the speed, the steering angle, the acceleration, and the like of the vehicle 1.

The sensor interface 140 acquires information from the first imaging device 16a, the second imaging device 16b, the third imaging device 16c, a fourth imaging device 16d, the internal imaging device 17, the steering system device 18, the seat sensor 19, the headrest sensor 20, the footrest sensor 21, the armrest sensor 22, the operation unit 23, and a distance measuring device 151. Note that, in FIG. 2, the first imaging device 16a, the second imaging device 16b, the third imaging device 16c, and the fourth imaging device 16d are simply referred to as an external imaging device. Moreover, the sensor interface 140 sends the acquired information to the fatigue recovery assistance unit 160 described later.

More specifically, the sensor interface 140 acquires an image around the vehicle 1 from the external imaging device 16. Moreover, the sensor interface 140 acquires a distance between an object around the vehicle 1 and the vehicle 1 from the distance measuring device 151.

The distance measuring device 151 detects an object around the vehicle 1 on the basis of a result of transmission and reception of a sound wave or an electromagnetic wave by the transmitter/receiver 15. For example, the distance measuring device 151 detects the object from a reflected sound wave received by the receiver. The distance measuring device 151 transmits a distance to the object around the vehicle 1 to the sensor interface 140. The object around the vehicle 1 is, for example, a preceding vehicle, a following vehicle, a pedestrian, a wall, a utility pole, a street tree, a building along a road, or the like. These objects may be simply referred to as obstacles.

The sensor interface 140 acquires the state of the driver imaged by the internal imaging device 17. Moreover, the sensor interface 140 acquires the content operated by the steering system device 18. For example, the sensor interface 140 acquires a steering angle of the steering wheel 18a, a degree of depression of the brake pedal 18b and the accelerator pedal 18c, and the operation content of a blinker lever 18d from the steering system device 18.

The sensor interface 140 acquires a state of the driving posture of the driver detected by the seat sensor 19. Moreover, the sensor interface 140 acquires a state in which the head of the driver leans, which is detected by the headrest sensor 20. Moreover, the sensor interface 140 acquires a state in which the foot of the driver is placed detected by the footrest sensor 21. The sensor interface 140 acquires a state in which the arm of the driver is placed detected by the armrest sensor 22.

Next, an outline of the fatigue recovery assistance unit 160 will be described. In the fatigue recovery assistance unit 160, the warning unit outputs a predetermined warning to the driver in a case where the automatic steering control is being executed in the vehicle, and the driver’s eyes are closed, and the driver is not in a predetermined awakening state, and the warning unit does not output the predetermined warning to the driver in a case where the automatic steering control is being executed in the vehicle, and the driver’s eyes are closed, and the driver is in the predetermined awakening state.

That is, this is a function of assisting the driver not to fall asleep while continuing the autonomous driving in a resting state without warning the driver even if the driver closes his/her eyes on the condition that the driver is in an awakening state during the autonomous driving, and the assistance is terminated at the time when the driver opens his/her eyes or cancels the autonomous driving. This assistance is referred to as fatigue recovery assistance, performing fatigue recovery assistance is referred to as application of fatigue recovery assistance, a function of performing fatigue recovery assistance is referred to as a fatigue recovery assistance function, and an application period of fatigue recovery assistance is referred to as a fatigue recovery assistance period.

In other words, the period in which the warning is not issued even if the driver closes the eyes on the condition that the driver is in the awakening state during the autonomous driving may be called the use period of the fatigue recovery assistance function. The driving assistance device 100 includes an input unit that receives an operation of the driver to select use of the fatigue recovery assistance function.

Alternatively, in a case where the automatic steering control is being executed in the vehicle, and the driver’s eyes are closed, and the driver is in a predetermined awakening state, the driving assistance device 100 may include an input unit that receives an input for selecting use of a driver assistance function in which the warning unit does not output the predetermined warning to the driver, and may receive the input by a predetermined switch (for example, a switch of the operation unit 23 or a switch that detects when a headrest, a footrest, or an armrest of the vehicle is touched).

Alternatively, in a case where utterance of a predetermined voice command is detected (for example, via the microphone 24), or in a case where the automatic steering control is being executed in the vehicle, and the driver’s eyes are closed, and the driver is in a predetermined awakening state, it may be determined that an input for selecting use of the fatigue recovery assistance function has been received. Alternatively, when there is an instruction to switch to the automatic steering control, it may be determined that an input for selecting the use of the fatigue recovery assistance function has been received.

When an input for selecting the use of the fatigue recovery assistance function is received, the fatigue recovery assistance unit 160 applies the fatigue recovery assistance in a case where the driver is in a state suitable for the use of the fatigue recovery assistance function. A time point at which the fatigue recovery assistance is applied and a time point at which the driver’s eyes are closed may be before or after each other. For example, the driver may close the eyes after selecting the use of the fatigue recovery assistance function, or may select the use of the fatigue recovery assistance function after closing the eyes.

In a case where the input unit for selecting the use of the fatigue recovery assistance function determines that the automatic steering control is being executed in the vehicle, and the driver’s eyes are closed, and the driver is in a predetermined awakening state, and receives an input for selecting the use of the fatigue recovery assistance function, the use of the fatigue recovery assistance function is selected after closing the eyes. Moreover, for example, in a case where fatigue is detected by monitoring the driver, in a case where the traveling time of the driver is long, the fatigue recovery assistance unit 160 proposes use of the fatigue recovery assistance function in a time zone in which fatigue or drowsiness is assumed, such as after a break for a meal.

Then, when the driver receives an input for selecting the use of the driver assistance function in response to the suggestion of the use, the fatigue recovery assistance is applied in a case where the driver is in a state suitable for the use of the fatigue recovery assistance function. Note that, in a case where the driver’s eyes are closed and the fatigue recovery assistance is applied, the warning unit does not output a warning on condition that the driver is in a predetermined awakening state, but when the fatigue recovery assistance is not applied, the warning unit outputs a warning to the driver regardless of the awakening state of the driver. Moreover, in a case where an input for selecting the use of the fatigue recovery assistance function is received, and in a case where a state is not suitable for the use of the fatigue recovery assistance function, the driving assistance control unit 167 to be described later performs control to create a state suitable for the use of the fatigue recovery assistance function.

Specifically, the vehicle 1 searches for a preceding vehicle that travels in the overtaking lane and at a constant speed in the traveling lane at a preferable speed, and changes the lane so as to enter behind the detected preceding vehicle, thereby bringing a lane suitable for using the driver assistance function (for example, a driving lane) into a state of traveling at a constant speed at a preferable speed while following the preceding vehicle, that is, a state suitable for using the fatigue recovery assistance function. This exercise may be performed automatically by the driving assistance control unit 167, or may be performed by notifying the driver of information related to the driving assistance control unit 167. Moreover, in a case where the road on which the vehicle is traveling is a general road, a route using an expressway may be proposed, and the driver may be guided to the expressway when the driver agrees with the proposal.

In other words, the control to create a state suitable for use of the driving assistance function performed by the driving assistance control unit 167 includes notifying the driver of at least one of guidance to a road of a type suitable for autonomous driving control, suggestion of switching to the autonomous driving control, guidance to a position following a preceding vehicle suitable for follow-up traveling, and guidance to a lane suitable for use of the driver assistance function, or at least one of movement to a road of a type suitable for autonomous driving control, switching to the autonomous driving control, movement to a position following a preceding vehicle suitable for follow-up traveling, and movement to a lane suitable for the driver assistance function. After performing control to create a state suitable for use of the driving assistance function, the driving assistance device 100 applies fatigue recovery assistance in a case where the state is suitable for use of the fatigue recovery assistance function.

Since the fatigue recovery assistance function recovers eyes and a body by relaxing them for a short time and does not continuously use them for a long time, it is not necessary to select a preceding vehicle in accordance with the distance to the destination and the average speed calculated from the estimated time of arrival. That is, the preferable speed may be a safe speed.

In this case, as the preceding vehicle, a vehicle having a maximum speed set according to a vehicle type, such as a bus or a large cargo vehicle, may be selected. This is because when the fatigue recovery assistance function is used, if the vehicle follows a large vehicle traveling at a relatively low speed, the vehicle is less likely to be interfered with a passenger vehicle traveling at a relatively high speed.

Moreover, the fatigue recovery assistance unit 160 may reduce acceleration, reduce vibration, reduce sound, reduce light stimulation, and adjust the seat in cooperation with the vehicle control unit 180 in order to recover the driver’s central fatigue. Central fatigue is fatigue of the cranial nervous system including the optic nerve, and is harmful to driving because it causes headache and deterioration in thinking ability. The central fatigue can be recovered by sleep, but if sleep is not available, it can also be recovered by closing the eyes to temporarily reduce the irritation experienced by the cranial nervous system and soothe the activity of the cranial nervous system.

The acceleration reduction is, for example, lane keeping, vehicle speed keeping, or the like. The reduction of the vibration is, for example, a decrease in vehicle height due to softening of the suspension or decompression of the air suspension. Moreover, in the case of a hybrid vehicle, the engine may be stopped, and the vehicle 1 may be driven only by the battery. Note that, in the case of an engine vehicle, the engine may be stopped because coasting is possible in a short time.

In the voice reduction, for example, the output of an unurgent voice message among voice messages output from the navigation device 29 is delayed until the fatigue recovery assistance period ends, the volume of radio broadcasting output from the speaker 25 is reduced, or the suppression rate of the active noise canceller is increased to reduce the noise level in the vehicle. The reduction of the light stimulus causes, for example, shielding of the windshield, dimming of the instrument panel or the like, and blackout of the navigation device 29. The adjustment of the seat is, for example, an operation of lowering the seat or tilting the seat. By adjusting the seat, the outside of the vehicle is outside the line of sight of the driver. Therefore, visual stimulation is reduced, and there is also an effect that the body of the driver is less disturbed.

Moreover, when the seat is tilted to reduce the seat pressure, the body can be easily relaxed. Since blood flow in peripheral blood vessels increases when the tension of the body is released, recovery of peripheral fatigue (muscle fatigue) can also be expected. However, when the body is relaxed, the parasympathetic nerve acts in a direction in which the parasympathetic nerve becomes dominant, and thereby the driver feels sleepy. Therefore, control for maintaining the awakening state is simultaneously required.

Next, unit included in the fatigue recovery assistance unit 160 will be described. The fatigue recovery assistance unit 160 includes a storage unit 161, an acquisition unit 162, an input unit 163, a first output unit 164, a vehicle state detection unit 165, a driver motion detection unit 166, a driving assistance control unit 167, a driver monitoring unit 168, a first clocking unit 169, a second clocking unit 170, a third clocking unit 171, a determination unit 172, a second output unit 173, a stimulus reducing unit 174, and a warning unit 175.

The storage unit 161 stores the contents acquired by the acquisition unit 162. Moreover, the storage unit 161 stores the contents received by the input unit 163. Moreover, the storage unit 161 stores the contents output by the first output unit 164. The storage unit 161 stores the result detected by the vehicle state detection unit 165. Moreover, the storage unit 161 stores a result detected by the driver motion detection unit 166. Moreover, the storage unit 161 stores the contents controlled by the driving assistance control unit 167. The storage unit 161 stores the contents monitored by the driver monitoring unit 168.

Moreover, the storage unit 161 records the time clocked by the first clocking unit 169. Moreover, the storage unit 161 records the time clocked by the second clocking unit 170. The storage unit 161 records the time clocked by the third clocking unit 171. Moreover, the storage unit 161 records a determination result of the determination unit 172. Moreover, the storage unit 161 records the contents output by the second output unit 173. The storage unit 161 records the contents output by the stimulus reducing unit 174. Moreover, the storage unit 161 records the contents output by the warning unit 175.

The storage unit 161 stores vehicle information, a first threshold, a second threshold, a third threshold, a fourth threshold, and a fifth threshold. The vehicle information is information on the size of the vehicle body of the vehicle 1. For example, the vehicle information includes a vehicle width and a vehicle length of the vehicle 1.

The first threshold is a threshold in which a time for confirming the awakening state is set. The first threshold is, for example, 25 seconds. The second threshold is a threshold in which an upper limit value of the fatigue recovery assistance is set. The second threshold is, for example, 120 seconds. The third threshold is a threshold in which the time for executing the awakening measures is set. The third threshold is, for example, 5 seconds. The fourth threshold is a threshold in which a time for executing strong awakening measures is set. The fourth threshold is, for example, 15 seconds. The fifth threshold is a threshold set with a time for executing the traveling stop measures. The fifth threshold is, for example, 30 seconds.

The storage unit 161 is implemented by, for example, a writable storage medium such as a random access memory (RAM), a flash memory, or a hard disk drive (HDD). Note that one storage unit 161 is illustrated in FIG. 2, whereas it may be implemented by a plurality of storage media. For example, each piece of information may be stored in different storage media. Note that the contents stored in the storage unit 161 are not limited thereto.

The acquisition unit 162 specifies the traveling state of the vehicle 1 from the vehicle state specification unit 130. Moreover, the acquisition unit 162 acquires, from the sensor interface 140, the vehicle sensor information, the surrounding image information, the other vehicle information, the state of the driver, the steering angle of the steering wheel 18a, the degree of depression of the brake pedal 18b and the accelerator pedal 18c, the operation content of the blinker lever 18d, the state of the driving posture of the driver, the state in which the head of the driver leans, the state in which the foot of the driver is placed, and the state in which the arm of the driver is placed.

For example, the vehicle sensor information is a detection result of an obstacle or the like around the vehicle 1 by the transmitter/receiver 15. For example, the surrounding image information is a video around the vehicle 1 captured by the external imaging device 16. Note that the surrounding image information may be included in the vehicle sensor information.

For example, the other vehicle information includes an image of the other vehicle captured by the external imaging device 16, and a distance and a speed between the host vehicle position and the other vehicle measured by the distance measuring device 151. The other vehicle information may include a vehicle width and a vehicle length of the other vehicle specified from the image of the other vehicle.

Moreover, the acquisition unit 162 acquires behavior history information from an external interface (not illustrated). Specifically, the acquisition unit 162 acquires the behavior history information from the external interface capable of communicating with the outside of the vehicle mounted on the vehicle 1.

The behavior history information is information of a behavior state of the driver and a behavior history including the behavior state of the driver. The behavior state includes at least one of fatigue information indicating a fatigue state of the driver, driving time information indicating a time during which the driver drives the vehicle 1, and eating and drinking time information indicating a time during which the driver eats and drinks. As the behavior history information, the behavior history may be input by operating the operation unit 23 operated by the driver. Moreover, the behavior history information may be acquired from management information (as an example, a calendar, a schedule, or the like) for managing the behavior of the driver.

The acquisition unit 162 acquires, from the operation unit 23, operation information operated by a user such as a driver or a passenger. Moreover, the acquisition unit 162 acquires, from the microphone 24, voice information obtained by collecting a voice uttered by a user such as a driver or a passenger.

The traveling state of the vehicle 1, the surrounding image information, the other vehicle information, the vehicle sensor information, the peripheral image information, the other vehicle information, the state of the driver, the steering angle of the steering wheel 18a, the degree of depression of the brake pedal 18b and the accelerator pedal 18c, the operation content of the blinker lever 18d, the state of the driving posture of the driver, the state in which the head of the driver leans, the state in which the foot of the driver is placed, the state in which the arm of the driver is placed, the behavior history information, the operation information, and the voice information acquired by the acquisition unit 162 are stored in the storage unit 161. Note that the information acquired by the acquisition unit 162 is not limited thereto.

The input unit 163 receives an input of the fatigue recovery assistance function. For example, the input unit 163 receives an input of an operation for the operation unit 23 to select the fatigue recovery assistance function according to the operation of the driver. Moreover, the input unit 163 receives an input for selecting a driver assistance function in which a warning unit 175 described later does not output a predetermined warning to the driver. The contents received by the input unit 163 are stored in the storage unit 161.

In a case where the input unit 163 receives an input for selecting the driving assistance function and in a case where a state is not suitable for use of the driving assistance function, the first output unit 164 outputs assistance information for prompting a state suitable for use of the driving assistance function. Specifically, in a case where the operation unit 23 receives an input of an operation for selecting the driving assistance function and the vehicle 1 is not suitable for use of the driving assistance function, the first output unit 164 outputs assistance information for prompting the vehicle 1 to be in a state suitable for use of the driving assistance function to the speaker 25 or the display 26. The output destination of the assistance information is physically the speaker 25 or the display 26, but since the final destination of the assistance information is the driver, the first output unit 164 may output, to the driver, the assistance information for prompting the driver to enter a state suitable for using the driving assistance function.

The assistance information includes at least one of guidance to a type of road suitable for autonomous driving control, guidance to a position following a preceding vehicle suitable for follow-up traveling, guidance to a lane suitable for a driver assistance function, and suggestion of switching to autonomous driving control. The first output unit 164 may output the assistance information to the display 26 to request the driver to take action. For example, the first output unit may directly output, to the navigation device 29, a request to change a route to a road (for example, an expressway or the like) of a type suitable for autonomous driving control, and may set, in the navigation device 29, a travel route (for example, a travel route through a nearest interchange to a destination by using an expressway or the like) suitable for use of the driving assistance function without bothering the driver.

Moreover, after the first output unit 164 outputs the assistance information for promoting a state suitable for use of the driving assistance function, in a case where the state becomes suitable for use of the driving assistance function, the first output unit outputs an instruction to activate the driving assistance function to the driving assistance control unit 167 described later. The first output unit 164 may output, to the driver, a message notifying that the driver is in a state suitable for using the driving assistance function, or may activate the driving assistance function when the driver selects the use of the fatigue recovery assistance function again. Moreover, in a case where the driving assistance function is activated without obtaining the driver’s consent, a message notifying that the driving assistance function is activated may be output to the driver. The instruction output by the first output unit 164 is stored in the storage unit.

In a case where the vehicle 1 is traveling at a substantially constant speed higher than or equal to a predetermined threshold, the vehicle state detection unit 165 detects that the vehicle 1 is in a cruising traveling state in which the vehicle 1 travels at a cruising speed. In a case where a preceding vehicle in which the vehicle 1 travels ahead is detected, a substantially constant inter-vehicle distance from the preceding vehicle is maintained, and the average speed of the vehicle 1 is traveling at a speed equal to or higher than a predetermined threshold, the vehicle state detection unit 165 detects a follow-up traveling state in which the vehicle 1 travels following the preceding vehicle. The vehicle state detection unit 165 detects that the vehicle 1 is in a congested traveling state in which the vehicle 1 detects a preceding vehicle, follows the preceding vehicle of the vehicle 1, and the average speed of the vehicle 1 is less than or equal to a predetermined threshold.

Specifically, the vehicle state detection unit 165 detects the cruising traveling state of the vehicle 1 from the traveling state of the vehicle 1 acquired by the acquisition unit 162. Moreover, the vehicle state detection unit 165 detects the follow-up traveling state and the congested traveling state from the traveling state of the vehicle 1, the surrounding image information, and the other vehicle information acquired by the acquisition unit 162. The contents detected by the vehicle state detection unit 165 are stored in the storage unit 161.

The driver motion detection unit 166 detects an open or closed state (whether closed or open) of the driver’s eyes. For example, the driver motion detection unit 166 detects an open or closed state (whether closed or open) of the driver’s eyes from the state of the driver acquired by the acquisition unit 162. Moreover, the driver motion detection unit 166 detects that the head of the driver touches the headrest of the vehicle 1. For example, the driver motion detection unit 166 detects that the head of the driver comes into contact with the headrest of the vehicle 1 from the state in which the head of the driver leans acquired by the acquisition unit 162.

Moreover, the driver motion detection unit 166 detects that a foot is placed on the footrest of the vehicle 1. For example, the driver motion detection unit 166 detects that the foot of the driver is placed on the footrest of the vehicle 1 from the state where the foot of the driver is placed acquired by the acquisition unit 162. The driver motion detection unit 166 detects that a foot is placed on a brake pedal of the vehicle 1. For example, the driver motion detection unit 166 detects that a foot is placed on the brake pedal of the vehicle 1 from the degree of depression of the brake pedal 18b acquired by the acquisition unit 162.

Moreover, the driver motion detection unit 166 detects that a hand is placed on the armrest of the vehicle 1. For example, the driver motion detection unit 166 detects that a hand is placed on an armrest of the vehicle 1 from the state where the arm of the driver acquired by the acquisition unit 162 is placed. Moreover, the driver motion detection unit 166 detects utterance of a predetermined keyword. For example, the driver motion detection unit 166 detects utterance of a predetermined keyword, for example, a voice command, from voice information acquired by the acquisition unit 162 by a voice recognition unit (not illustrated).

The driver motion detection unit 166 detects an operation of a predetermined button or switch. For example, the driver motion detection unit 166 detects an operation of a predetermined button or switch from the operation information acquired by the acquisition unit 162. The result detected by the driver motion detection unit 166 is stored in the storage unit 161.

The driving assistance control unit 167 controls an assisting operation for recovering driver’s fatigue from the driver. For example, the driver’s fatigue includes eye fatigue and body fatigue. Note that the driver’s fatigue is not limited thereto.

When the vehicle 1 is in autonomous driving and the driver’s eyes are closed when the fatigue recovery assistance is available, the driving assistance control unit 167 starts application of the fatigue recovery assistance. Specifically, the driving assistance control unit 167 determines a motion policy so that the vehicle 1 can continue autonomous driving even in a state where the driver’s eyes are closed. Moreover, the driving assistance control unit 167 notifies the driver of the availability of the fatigue recovery assistance after the determination of the motion policy. The driver may close his/her eyes after receiving the notification that the fatigue recovery assistance is available.

More specifically, the driving assistance control unit 167 controls the assistance operation during autonomous driving or driving assistance on the basis of the information acquired from the sensor interface 140. Specifically, the driving assistance control unit 167 determines a motion policy or a travel mode, and specific control of the vehicle 1 is performed by the vehicle control unit 180 on the basis of the motion policy. The control of the vehicle 1 is a vehicle main body that travels while performing acceleration/deceleration, braking, maintaining and changing a course, and the like, receives an instruction of a steering angle and acceleration/deceleration from the vehicle control unit 180 via a LAN, and periodically outputs information of the steering angle, the vehicle speed, and the driving force to the LAN. The driving assistance control unit 167 also uses information output from the vehicle control unit 180 to determine a motion policy.

The motion policy is, for example, following a preceding vehicle or a lane change. Specifically, a motion policy that is continuously applied, such as following a preceding vehicle, may be collectively referred to as a travel mode. When the traveling mode is the preceding vehicle following, the driving assistance control unit 167 acquires the distance to the preceding vehicle and the approaching speed (speed difference) by radar, for example, and estimates the speed of the preceding vehicle by adding information of the vehicle speed obtained from the vehicle system. When the distance to the preceding vehicle is within a predetermined threshold, a target inter-vehicle distance to the preceding vehicle is calculated according to the speed of the preceding vehicle, and this target inter-vehicle distance added to the traveling mode is given to the vehicle control unit 180 as one motion policy.

If the travel mode is the preceding vehicle following, the vehicle control unit 180 compares the target inter-vehicle distance with the distance to the preceding vehicle and determines whether acceleration or deceleration is necessary. In a case where acceleration or deceleration is necessary, the vehicle control unit 180 determines an acceleration rate or a deceleration rate such that the acceleration given to the occupant falls within an allowable range, and gives a command to the vehicle system in accordance with the determination.

Moreover, when the travel mode is the lane keeping mode, the driving assistance control unit 167 analyzes the image obtained from the camera, calculates the lateral position of the host vehicle in the lane, and sends information on the lateral position of the host vehicle to the vehicle control unit 180. Moreover, the vehicle control unit 180 determines a target value of the steering angle according to the information of the lateral position of the host vehicle, and the vehicle system controls the steering angle so as to match the target value of the steering angle.

The content described above is the operation of the vehicle when the autonomous driving or the driving assistance similar to the autonomous driving is performed, and the mode of the operation is different in the manual driving. Specifically, the vehicle control unit 180 determines the steering angle, the acceleration rate, or the deceleration rate according to the operation amount (as an example, the angle of the handle and the amount of stepping-in) detected by the steering wheel, the accelerator, or the brake, and the vehicle system operates according to the determination. That is, in manual driving, since the operation of the driver determines the operation of the vehicle system, the driver needs to open his/her eyes and instruct the vehicle system on an exercise policy (for example, a course or a speed). Therefore, the fatigue recovery assistance of the present embodiment is not established by manual driving.

As driving assistance that is not included in driving assistance similar to autonomous driving, for example, there are an approaching object warning that detects an approaching object with a radar and gives a warning, an automatic brake that detects an approach to a preceding vehicle and operates, and the like. This is a safety ensuring function that functions even without an instruction from the driver, and thus is not often recognized as driving assistance. The fatigue recovery assistance is a function that can be applied only when the autonomous driving or the driving assistance similar to the autonomous driving is performed, but the safety ensuring function such as the automatic brake continues the function regardless of whether the autonomous driving or the fatigue recovery assistance is applied.

In the case of automatic braking, the driving assistance control unit 167 determines information obtained from a camera, a sonar, a radar, or the like, detects an obstacle, adds information of a steering angle and a speed output by the vehicle control unit 180, calculates presence or absence of a possibility of collision and a time until collision, determines necessity of emergency braking, and executes emergency braking if necessary. Even when the fatigue recovery assistance is applied, if there is a possibility of collision, the vehicle avoids the collision by executing the emergency braking. Therefore, even if the driver closes his/her eyes, a serious situation does not occur.

In a case where the vehicle system performs an operation that does not depend on the operation of the driver, such as the execution of the emergency braking, the driver is notified that the driving assistance is performed by voice and video via the speaker 25 and the display 26, for example. Note that in the case of performing the emergency braking, it is preferable to determine that the fatigue recovery assistance is no longer available, stop the fatigue recovery assist, and simultaneously notify the stop of the fatigue recovery assistance in order to promote safety and confirmation of the situation.

The driver monitoring unit 168 identifies the driver and stores, for each driver, the travel time within the past 24 hours of the identified driver. The driver monitoring unit 168 estimates the fatigue level from the traveling time after the start of traveling of the vehicle 1 and the traveling time before that. When estimating that the fatigue level is high, the driver monitoring unit 168 proposes the use of the fatigue recovery assistance function. The driver monitoring unit 168 compares the travel time during which the driver has traveled within the past 24 hours with a predetermined time threshold, and estimates that the fatigue level is high when the travel time is larger than the time threshold.

The driver monitoring unit 168 monitors the state of the eyes of the driver of the vehicle 1 and the awakening state of the driver. The awakening state indicates, for example, a state in which a part of the body of the driver reacts to the voice output from the speaker 25 so as to correspond to the output voice. As an example, when the speaker 25 outputs a voice message “Please tap on the steering wheel”, it can be said that the state in which the driver taps the steering wheel 18a so as to correspond to the voice message is the awakening state.

Moreover, the driver monitoring unit 168 applies the inquiry stimulus to the driver, and determines the awakening state of the driver on the basis of a predetermined response determination condition for determining a response to the inquiry stimulus. The inquiry stimulus may be any stimulus that can be sensed by the driver with the eyes closed, and may be, for example, a voice message, an electronic sound, or vibration.

The predetermined response determination condition includes at least one of the presence or absence of a response of the driver to the inquiry stimulus, the strength of a response of the driver to the inquiry stimulus, and the response time until a response to the inquiry stimulus is made. Moreover, the response determination condition may be a threshold of the strength of response at the time of determining that there is a response to the inquiry stimulus, or a threshold of the response time from the time point at which the inquiry stimulus is applied to the time point at which it is determined that there is no response.

For example, when the switch incorporating the vibrator 27 provided on the armrest of the driver is turned off after being turned on within 3 seconds from the time when the switch is vibrated, it may be determined that the response of the driver to the inquiry stimulus satisfies the predetermined condition. Since the pressing of the switch requires a force exceeding a mechanical reaction force, it is possible to determine that the strength of the response exceeds the threshold.

In a case where a determination is made such that there is a response to the inquiry stimulus, the driver monitoring unit 168 determines that the driver is in the predetermined awakening state. The inquiry stimulus includes at least one of a light ray stimulus, a tactile stimulus, and a voice. Moreover, the inquiry stimulus is a stimulus weaker than a warning given to the driver by the warning unit 175 described later. Since the inquiry stimulus has a role of notifying the driver who is at rest with his/her eyes closed of a timing at which a response should be returned, a stimulus that is weak enough to be perceptible by the driver is preferable. When the inquiry stimulus is an excessively strong stimulus, the driver may be startled or tensioned, which hinders relaxation.

Moreover, the driver monitoring unit 168 intensifies the inquiry stimulus in a case where a response of the driver to the inquiry stimulus does not satisfy a predetermined condition. For example, when the awakening level (degree of awakening) of the driver decreases and the hand relaxes, the switch built in the vibrator 27 described above may be provided at a position where the hand is released (for example, the back side of the armrest), the first inquiry stimulus may be a weak vibration that cannot be felt without touching the switch, and the intensified inquiry stimulus may be a strong vibration that can be felt even with an armrest.

In a case where there is no response to the initial inquiry stimulus and there is a response to the intensified inquiry stimulus, the driver monitoring unit 168 may determine that the driver is in the predetermined awakening state at a time point when there is a response to the initial inquiry stimulus without making a determination at a time point when there is no response to the initial inquiry stimulus, or may determine that the driver is not in the predetermined awakening state at a time point when there is no response to the initial inquiry stimulus and determine that the driver is in the predetermined awakening state at a time point when there is a response to the intensified inquiry stimulus, or may determine that the awakening level of the driver has decreased. The driver monitoring unit 168 may repeat the intensification of the inquiry stimulus, and may determine that the slower the response, the lower the awakening level of the driver.

The first clocking unit 169 starts clocking at a timing when the fatigue recovery assistance unit 160 starts applying the fatigue recovery assistance. The first clocking unit 169 is used for the purpose of determining the timing of applying the inquiry stimulus. The first clocking unit 169 may be initialized during a period in which fatigue recovery assistance is applied. The second clocking unit 170 starts clocking at the timing when the fatigue recovery assistance unit 160 starts applying the fatigue recovery assistance.

Since the second clocking unit 170 is used for the purpose of determining the timing of ending the fatigue recovery assistance, it is not initialized during the period in which the fatigue recovery assistance is applied. The third clocking unit 171 starts clocking at a timing when the driver monitoring unit 168 applies an inquiry stimulus to the driver. The third clocking unit 171 is used for the purpose of determining a timing at which it is determined that the driver is not in the predetermined awakening state.

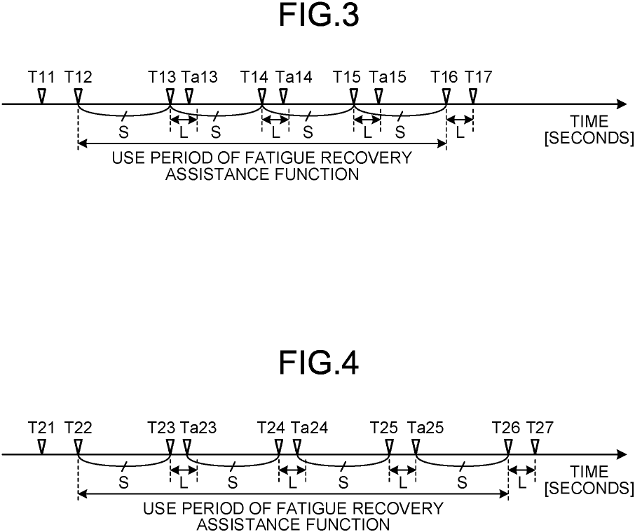

The timing at which the driving assistance device 100 provides fatigue recovery assistance will be described with reference to FIGS. 3 and 4. The horizontal axis illustrated in FIGS. 3 and 4 represents time (“seconds”).

Time T11 illustrated in FIG. 3 is a timing at which the automatic steering control is started. Time T12 is a timing at which the driver’s eyes are closed, and is a timing at which the application of the fatigue recovery assistance starts. Note that it is assumed that the fatigue recovery assistance is performed between time T12 and time T16. The first clocking unit 169 and the second clocking unit 170 start clocking at the timing of the time T12.

Time T13 is a timing at which the time clocked by the first clocking unit 169 exceeds a predetermined threshold (S), and is a timing at which the driver monitoring unit 168 applies an inquiry stimulus to the driver. When the driver monitoring unit 168 applies an inquiry stimulus to the driver, the first clocking unit 169 initializes the clocked time and starts clocking again. The third clocking unit 171 starts clocking at a timing (time T13) when the driver monitoring unit 168 applies an inquiry stimulus to the driver, and determines that the driver monitoring unit 168 confirms the awakening state of the driver when the driver responds at a timing (time Ta13) before the time clocked by the third clocking unit 171 exceeds a predetermined threshold (L).

Time T14 is a timing at which the time clocked by the first clocking unit 169 exceeds a predetermined threshold (S), and is a timing at which the driver monitoring unit 168 applies an inquiry stimulus to the driver. When the driver monitoring unit 168 applies an inquiry stimulus to the driver, the first clocking unit 169 initializes the clocked time and starts clocking again. A determination is made such that the driver monitoring unit 168 confirms the awakening state of the driver at a timing (time Ta14) when the driver responds within a predetermined time (L) from the time T14. Thereafter, the same operation is repeated at time T15.

Time T16 is a timing at which the time clocked by the second clocking unit 170 exceeds a predetermined threshold, and is a timing at which the application of the fatigue recovery assistance ends (the driver ends the use of the fatigue recovery assistance function). The fatigue recovery assistance unit 160 prompts the driver to open his/her eyes at the timing of the time T16, and ends the application of the fatigue recovery assistance. For example, the speaker 25 may output, to the driver, the content for ending the application of the fatigue recovery assistance by voice. The driver notified of the end of the fatigue recovery assistance is expected to open his/her eyes voluntarily.

Time T17 is a timing at which the warning unit 175 outputs a predetermined warning to the driver when the driver does not open his/her eyes. The timing (time T17) at which a determination that the driver does not open the eyes is made may be clocked using the first clocking unit 169, or the same time threshold (L) as that used when the awakening state is confirmed may be used. The warning unit 175 outputs a predetermined warning to the driver in a case where the driver’s eyes are not opened by the time T17.

While FIG. 3 illustrates an example in which the interval of applying the inquiry stimulus to the driver is constant, the timing of applying the inquiry stimulus to the driver may be determined from the timing of responding to the inquiry stimulus to the driver as a starting point. Time T21 illustrated in FIG. 4 is a timing at which the automatic steering control is started. Time T22 is a timing at which the head of the driver comes into contact with the headrest, and is a timing at which the application of the fatigue recovery assistance starts. Since the start condition of the fatigue recovery assistance is not limited to that the driver closes his/her eyes, the timing at which the driver closes his/her eyes may be around T22.

Note that it is assumed that the fatigue recovery assistance is applied between time T22 and time T26. In a case where the driver continuously opens his/her eyes beyond a predetermined time threshold during the use period of the fatigue recovery assistance function (during the application period of the fatigue recovery assistance), the application of the fatigue recovery assistance may be ended by estimating that the driver has indicated an intention to end the use of the fatigue recovery assistance function, or if the driver has opened his/her eyes for a short time less than or equal to the threshold (for example, blinking), the application of the fatigue recovery assistance may be continued by estimating that the driver has no intention to end the use of the fatigue recovery assistance function. The first clocking unit 169 and the second clocking unit 170 start clocking at the timing of the time T22.

Time T23 is a timing at which the time clocked by the first clocking unit 169 exceeds a predetermined threshold (S), and is a timing at which the driver monitoring unit 168 applies an inquiry stimulus to the driver. The third clocking unit 171 starts clocking at a timing (time T23) when the driver monitoring unit 168 applies an inquiry stimulus to the driver, and determines that the driver monitoring unit 168 confirms the awakening state of the driver in a case where the driver responds at a timing (time Ta23) before the time clocked by the third clocking unit 171 exceeds a predetermined threshold (L).

When the driver monitoring unit 168 confirms the awakening state of the driver, the first clocking unit 169 initializes the clocked time and starts clocking again. Time T24 is a timing at which the time clocked by the first clocking unit 169 exceeds a predetermined threshold (S), and is a timing at which the driver monitoring unit 168 applies an inquiry stimulus again to the driver. When the driver monitoring unit 168 confirms the awakening state of the driver, the first clocking unit 169 initializes the clocked time and starts clocking again. Thereafter, the same operation is repeated at time T25.

In a case where the time measured by the second clocking unit 170 exceeds the predetermined threshold at time T26, the fatigue recovery assistance unit 160 determines that it is the timing to end the application of the fatigue recovery assistance (to end the use of the fatigue recovery assistance function). The fatigue recovery assistance unit 160 prompts the driver to open his/her eyes at the timing of the time T26, and ends the application of the fatigue recovery assistance. For example, the speaker 25 may output, to the driver, the content for ending the application of the fatigue recovery assistance by voice.

Time T27 is a timing at which the warning unit 175 outputs a predetermined warning to the driver when the driver does not open his/her eyes. The warning unit 175 outputs a predetermined warning to the driver in a case where the driver does not open his/her eyes by the time T27. As illustrated in FIGS. 3 and 4, the response of the driver may become slower as the time from closing the eyes becomes longer. This is a sign that appears in the process of decreasing the awakening level, and the time from when a predetermined warning is output to the driver until the driver becomes able to drive tends to be longer as the awakening level decreases.

In the present embodiment, a decrease in the awakening level is suppressed by providing an upper limit to the use period of the fatigue recovery assistance function. Moreover, the upper limit of the use period of the fatigue recovery assistance function prevents the use of a deception device that detects and responds to an inquiry stimulus for the purpose of dozing off.

Returning to FIG. 2. The determination unit 172 determines whether the warning unit 175 outputs a predetermined warning to the driver. The determination unit 172 determines whether the automatic steering control is being executed in the vehicle 1, and the driver’s eyes are closed, and the driver is in a predetermined awakening state. Moreover, the determination unit 172 determines whether the automatic steering control of the vehicle 1 is not being executed and the driver’s eyes are continuously closed for a first time or more.

The determination unit 172 determines whether the situation corresponds to a case where the automatic steering control is being executed in the vehicle 1, and the driver’s eyes are continuously closed for a first time or more, and the driver is not in a predetermined awakening state. The determination unit 172 determines whether the situation corresponds to a case where the automatic steering control is being executed in the vehicle 1, and the driver’s eyes are continuously closed for 2 hours or more, and the driver is in a predetermined awakening state.

The first time and the second time are thresholds for determining whether or not the warning unit 175 outputs a predetermined warning to the driver. The determination unit 172 uses the first time as the threshold in a case where the driver is not in the predetermined awakening state, and uses the second time as the threshold in a case the driver is in the predetermined awakening state. The first time is shorter than the second time. Note that the first time and the second time are stored in the storage unit 161.

The determination unit 172 determines whether the automatic steering control is being executed in the vehicle 1, and the driver’s eyes are continuously closed for a predetermined time or more, and the driver is in a predetermined awakening state, and the warning unit 175 outputs a predetermined warning to the driver according to the determination result. For example, in a case where the determination unit 172 determines that the automatic steering control is not executed in the vehicle 1 and the driver’s eyes are continuously closed for a first time or more, the warning unit 175 may output a predetermined warning.

Alternatively, in a case where the determination unit 172 determines that the automatic steering control is being executed in the vehicle 1, and the driver is not in the predetermined awakening state, and the driver’s eyes are continuously closed for the first time or more, the warning unit 175 may output a predetermined warning. Alternatively, in a case where the determination unit 172 determines that the automatic steering control is being executed in the vehicle 1, and the driver is in a predetermined awakening state, and the driver’s eyes are continuously closed for a second time or more, the warning unit 175 may output a predetermined warning.

Since the first time is shorter than the second time, the second time is longer than the first time. Therefore, in a case where the automatic steering control is being executed in the vehicle 1, and the driver is in the predetermined awakening state, the time until the warning is output is longer than when the automatic steering control is not executed in the vehicle 1 or the driver is not in the predetermined awakening state. As a result, the driver can recover the fatigue by closing the eyes for a longer time without being bothered by the warning as long as the driver is in the predetermined awakening state.

Here, the assistance start condition will be described. When the assistance start condition is satisfied, the fatigue recovery assistance can be applied. In a case where the assistance start condition is not satisfied and the fatigue recovery assistance is not applied, if the driver closes his/her eyes longer than the first time, the driver receives a warning from the warning unit 175. On the other hand, in a case where the assistance start condition is satisfied and the fatigue recovery assistance is applied, the driver can recover his/her fatigue by closing his/her eyes without being bothered by the warning for the second time longer than the first time.

At the time when the fatigue recovery assistance is applied, in particular, at the time when the time from the closing of the eyes of the driver exceeds the first time and does not exceed the second time, the warning unit 175 outputs a predetermined warning to the driver in a case where the assistance start condition is satisfied, and the automatic steering control is being executed in the vehicle 1, and the eyes of the driver are closed, and the driver is not in the predetermined awakening state, and the warning unit 175 does not output a predetermined warning to the driver in a case where the assistance start condition is satisfied, and the automatic steering control is being executed in the vehicle 1, and the eyes of the driver are closed, and the driver is in the predetermined awakening state.

The assistance start condition is satisfied by the driver selecting the use of the fatigue recovery assistance function, and the condition includes at least one condition of receiving an instruction to switch to the automatic steering control, detecting an eye closing operation that the driver closes eyes, detecting that a head of the driver touches a headrest of the vehicle 1, detecting that a foot is placed on a footrest of the vehicle 1, detecting that a foot is placed on a brake pedal of the vehicle 1, detecting that a hand is placed on an armrest of the vehicle 1, detecting utterance of a predetermined keyword, and detecting an operation of a predetermined button or switch.

Since the assistance start condition is that the driver indicates an intention to use the driver assistance function that does not warn the driver if the driver’s eyes are closed but in a predetermined awakening state by the action of the driver, the action of another driver may be added to the condition, it may be determined that the assistance start condition is satisfied when a combination of a plurality of conditions is satisfied, or a time condition may be added to the determination condition.

For example, in a case where the start operation to be described later is not performed within 10 seconds after the switching instruction to the automatic steering control is received, it may be estimated that the driver has not selected the use of the fatigue recovery assistance function, and it may be determined that the assistance start condition is not satisfied thereafter. Moreover, a determination that the assistance start condition is satisfied is made in response to determining that the head of the driver comes into contact with the headrest of the vehicle and the hand is separated from the steering wheel continuously within 3 seconds, and it is not necessary to determine that the assistance start condition is satisfied when it is detected at different timings separated by 3 seconds or more.

Moreover, the assistance start condition is not limited to the driver’s intention, and the traveling state of the vehicle should also be included in the assistance start condition. Therefore, the driver’s intention is referred to as a first assistance start condition, and a condition of the traveling state of the vehicle to be described later is referred to as a second assistance start condition.

The determination unit 172 determines whether or not the first assistance start condition is satisfied, and the second assistance start condition is satisfied, and the automatic steering control is being executed in the vehicle 1, and the driver’s eyes are closed, and the driver is in a predetermined awake state.

Here, the second assistance start condition will be described. In a case where the second assistance start condition is satisfied together with the first assistance start condition, the fatigue recovery assistance can be applied, and the driver can recover the fatigue by closing the eyes without being bothered by the warning for the second time longer than the first time.

At the time when the fatigue recovery assistance is applied, in particular, at the time when the time from the closing of the eyes of the driver exceeds the first time and does not exceed the second time, the warning unit outputs a predetermined warning to the driver in a case where the first assistance start condition is satisfied, and the second assistance start condition is satisfied, and the automatic steering control is being executed in the vehicle, and the eyes of the driver are closed, and the driver is not in the predetermined awakening state, and the warning unit does not output a predetermined warning to the driver in a case where the first assistance start condition is satisfied, and the second assistance start condition is satisfied, and the automatic steering control is being executed in the vehicle, and the eyes of the driver are closed, and the driver is in the predetermined awakening state.

The second assistance start condition includes at least one condition of detecting that the vehicle 1 is in a cruising traveling state in which the vehicle travels at a cruising speed, detecting that the vehicle 1 is in a follow-up traveling state in which the vehicle 1 follows a preceding vehicle of the vehicle 1, and detecting that the vehicle is in a congested traveling state in which an average speed of the vehicle 1 is less than or equal to a predetermined threshold.

In the driver assistance function of not warning the driver, which is shown in the present embodiment, even when the driver’s eyes are closed as long as the driver’s eyes are in a predetermined awakening state, the driving assistance can be started on condition that the automatic steering control is being executed in the vehicle 1. Therefore, the second assistance start condition may be paraphrased as that the automatic steering control is being executed in the vehicle 1, and the second assistance start condition may be determined to be satisfied in a state where the automatic steering control is being executed in the vehicle 1 without being limited to the cruising traveling state, the follow-up traveling state, and the congested traveling state.

For example, in a case where the autonomous driving control including the automatic steering control and the inter-vehicle distance control is executed in the vehicle 1, when another vehicle cuts in between the preceding vehicle that is a target of follow-up traveling and the vehicle 1, it may be determined that the second assistance start condition is continuously satisfied if the autonomous driving control appropriately responds and can maintain a safe inter-vehicle distance with the other vehicle that has cut in.

The determination unit 172 can determine information indicating whether the eyes are closed or open, that is, the opening/closing information of the eyes from the opening/closing state of the eyes of the driver detected by the driver motion detection unit 166. The result determined by the determination unit 172 is stored in the storage unit 161. Note that the driver monitoring unit 168 may function as the determination unit 172.

In a case where the automatic steering control is being executed in the vehicle 1, and the driver’s eyes are closed, and the driver is in a predetermined awakening state, the second output unit 173 outputs, to the driver, a suggestion for using the driver assistance function in which the warning unit 175 does not output a predetermined warning to the driver. At this time, if the driver selects the use, the driver may close his/her eyes to recover from fatigue, and if the driver does not select the use, the driver may output, from the speaker 25 or the display 26, a usage suggestion message notifying that a warning is received in a predetermined time.

When the selection of the driver for the message can be received by the microphone 24, it is preferable because the use of the fatigue recovery assistance function can be selected even with the eyes closed. The output destination of the usage suggestion is physically the speaker 25 or the display 26, but since the final destination of the usage suggestion is the driver, the second output unit 173 may output, to the driver, the usage suggestion of the driver assistance function that does not output the predetermined warning to the driver.

Moreover, the second output unit 173 outputs the suggestion for using the driver assistance function on the basis of at least one of a behavior state of the driver, a behavior history including the behavior state of the driver, and whether or not the state is suitable for the driver assistance function. For example, the second output unit 173 may calculate the fatigue level from the behavior state of the driver (for example, the duration or the detection frequency of the state in which the eyes are closed), output the suggestion for using the driver assistance function when the fatigue level exceeds a predetermined threshold, and lower the predetermined threshold when the state is suitable for the driver assistance function than when the state is not suitable for the driver assistance function.

When the driver assistance function is applied, the stimulus reducing unit 174 performs a predetermined stimulus reduction on the driver. For example, the stimulus reducing unit 174 performs a predetermined stimulus reduction in a case where the automatic steering control is being executed in the vehicle 1, and the driver’s eyes are closed, and the driver is in a predetermined awakening state.

Here, the predetermined stimulus reduction includes at least one of reducing vibration received by the driver, reducing acceleration received by the driver, notifying the driver of a behavior of the vehicle 1 in a case where the driver receives acceleration due to a behavior of the vehicle, reducing sound entering ears of the driver, reducing light stimulus entering eyes of the driver, reducing a seat pressure received by buttocks of the driver, and reducing a pressure received by the driver from a seat belt.

The stimulus reducing unit 174 performs a predetermined stimulus reduction on the driver, thereby shifting the driver to a more comfortable state and leading to recovery assistance.

The warning unit 175 outputs a warning to the driver. Specifically, the warning unit 175 outputs a predetermined warning to the driver in a case where the automatic steering control is being executed in the vehicle 1, and the use of the driver assistance function of not outputting a predetermined warning to the driver when the driver’s eyes are closed is not selected, and the driver’s eyes are closed. The warning unit 175 outputs a predetermined warning to the driver in a case where the automatic steering control is being executed in the vehicle 1, and the use of the driver assistance function of not outputting a predetermined warning to the driver when the driver’s eyes are closed is selected, and the driver’s eyes are closed, and the driver is not in a predetermined awakening state. Moreover, the warning unit 175 does not output a predetermined warning to the driver in a case where the automatic steering control is being executed in the vehicle 1, and the use of the driver assistance function of not outputting a predetermined warning to the driver when the driver’s eyes are closed is selected, and the driver’s eyes are closed, and the driver is in a predetermined awakening state.

The predetermined warning is, for example, a warning by voice output from the speaker 25. The speaker 25 outputs a voice such as “Are you awake?” to the driver. The predetermined warning may be a weak tactile stimulus (for example, vibration) by at least one of the seat of the vehicle 1, the armrest of the vehicle 1, the footrest of the vehicle 1, the headrest of the vehicle 1, the steering wheel of the vehicle 1, the pedal of the vehicle 1, and the seat belt of the vehicle 1, or a weak tactile stimulus may be output simultaneously with a warning by voice. The output destination of the warning is physically the speaker 25 or the device of the vehicle 1 touched by the driver, but since the final destination of the warning is the driver, the warning unit 175 may output a predetermined warning to the driver.

The warning unit 175 outputs a predetermined warning to the driver in a case where the automatic steering control of the vehicle 1 is not executed, and the driver’s eyes are closed. The warning unit 175 does not output a predetermined warning to the driver in a case where the driver’s eyes are open.

The warning unit 175 outputs a predetermined warning to the driver in a case where the automatic steering control is being executed in the vehicle 1, and the use of the driver assistance function of not outputting a predetermined warning to the driver when the driver’s eyes are closed is selected, and the driver’s eyes are continuously closed for a first time or more, and the driver is not in a predetermined awakening state. The warning unit 175 outputs a predetermined warning to the driver in a case where the automatic steering control is being executed in the vehicle 1, and the use of the driver assistance function of not outputting a predetermined warning to the driver when the driver’s eyes are closed is selected, and the eyes of the driver are continuously closed for a second time or more, and the driver is in a predetermined awakening state.

Here, since the first time that is the time until warning when the driver is not in the predetermined awakening state is shorter than the second time that is the time until warning when the driver is in the predetermined awakening state, the driver can recover from fatigue with eyes closed for a longer time on condition that the driver is in the awakening state.

The warning unit 175 outputs a predetermined warning to the driver in a case where the first assistance start condition is not satisfied, and the driver’s eyes are continuously closed for a first time or more. The warning unit 175 outputs a predetermined warning to the driver in a case where the second assistance start condition is not satisfied, and the driver’s eyes are continuously closed for a first time or more. The warning unit 175 outputs a predetermined warning to the driver in a case where the automatic steering control is not executed in the vehicle 1, and the driver’s eyes are continuously closed for a first time or more.

The warning unit 175 outputs a predetermined warning to the driver in a case where the first assistance start condition is satisfied, and the second assistance start condition is satisfied, and the automatic steering control is being executed in the vehicle 1, and the driver’s eyes are continuously closed for a first time or more, and the driver is not in a predetermined awakening state. In a case where the first assistance start condition is satisfied, and the second assistance start condition is satisfied, and the automatic steering control is being executed in the vehicle 1, and the driver’s eyes are closed, and the driver is in a predetermined awakening state, the warning unit 175 does not output the predetermined warning to the driver even if the driver’s eyes are continuously closed for less than the second time.

However, the case where the predetermined warning is not output to the driver is a case where the use of the driver assistance function in which the predetermined warning is not output to the driver when the driver’s eyes are closed is selected on the condition that the driver’s eyes are closed. In a case where the use of the driver assistance function of not outputting the predetermined warning to the driver when the driver’s eyes are closed is selected, the warning unit 175 does not output the predetermined warning to the driver even if the driver’s eyes are continuously closed for less than the second time on condition that the driver is in a predetermined awakening state.

In a case where the driver is not in a predetermined awakening state, the warning unit 175 outputs a predetermined warning to the driver and applies an awakening stimulus to a body of the driver.

The awakening stimulus includes at least one of a tactile stimulus by at least one of a seat of the vehicle 1, an armrest of the vehicle 1, a footrest of the vehicle 1, a headrest of the vehicle 1, a steering wheel of the vehicle 1, a pedal of the vehicle 1, and a seat belt of the vehicle 1, an acceleration stimulus under control of a speed reducer or a steering angle controller, an auditory stimulus by a sound emitted by the vehicle 1, and a light ray stimulus to an eyelid of a driver. Note that the awakening stimulus is divided according to the intensity of the stimulus, and the weak awakening stimulus is referred to as a first awakening stimulus. An awakening stimulus stronger than the first awakening stimulus is also referred to as a second awakening stimulus.

The tactile stimulation is, for example, vibrating a vibrator 27 provided on a seat of the vehicle 1, an armrest of the vehicle 1, a footrest of the vehicle 1, a headrest of the vehicle 1, a steering wheel of the vehicle 1, a pedal of the vehicle 1, and a seat belt of the vehicle 1 to make the driver feel vibration, increase tension of the seat belt of the vehicle 1, or change an angle or a height of the seat of the vehicle 1 on which the driver sits.

The acceleration stimulation is, for example, to swing the body of the driver by accelerating or decelerating the vehicle 1 or slightly swinging the steering angle of the vehicle 1. The auditory stimulus is, for example, a warning by voice output from the speaker 25. The light ray stimulus is, for example, a fall of a vehicle interior lamp, a stop of light-shielding of a windshield, an increase in luminance of an instrument display, a stop of blackout of the navigation device 29, or an increase in luminance.

Moreover, in a case where the driver is not in the predetermined awakening state, the warning unit 175 outputs a predetermined warning to the driver and applies the first awakening stimulus to the body of the driver, and in a case where the driver does not shift to an awakening state within a predetermined time after the first awakening stimulus is applied, at least one of actions of applying the driver a second awakening stimulus stronger than the first awakening stimulus, decelerating or stopping the vehicle 1, and ending the autonomous driving control is executed.

The second awakening stimulus that is stronger than the first awakening stimulus is, for example, a strong vibration by the vibrator 27, a change in the tension of the seat belt, an intermittent acceleration stimulus under the control of the speed reducer or the steering angle controller, a loud auditory stimulus by the sound output from the speaker 25, or a strong ray stimulus to the driver’s eyelid.

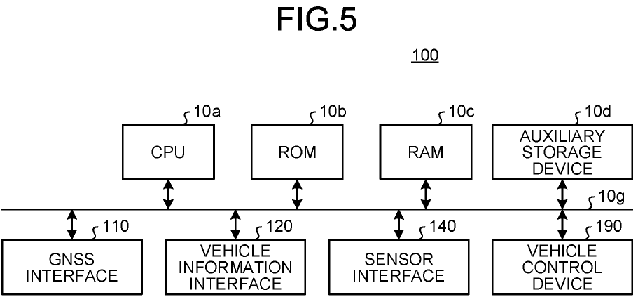

Next, a hardware configuration of the driving assistance device 100 will be described. FIG. 5 is a diagram illustrating an example of a hardware configuration of the driving assistance device 100 according to the embodiment. As illustrated in FIG. 5, in the driving assistance device 100, for example, a central processing unit (CPU) 10a, a read only memory (ROM) 10b, a RAM 10c, an auxiliary storage device 10d, a GNSS interface 110, a vehicle information interface 120, a sensor interface 140, and a vehicle control device 190 are mutually connected by a bus 10g. The driving assistance device 100 has a hardware configuration utilizing a normal computer.

The CPU 10a is an arithmetic device that controls the entire driving assistance device 100. The ROM 10b stores computer programs and the like for implementing various processing by the CPU 10a. The RAM 10c and the auxiliary storage device 10d store data necessary for various processing by the CPU 10a. Note that the driving assistance device 100 may include a hard disk drive (HDD).

When the CPU 10a of the driving assistance device 100 executes the computer program stored in the ROM 10b, the functions of the acquisition unit 162, the input unit 163, the first output unit 164, the vehicle state detection unit 165, the driver motion detection unit 166, the driving assistance control unit 167, the driver monitoring unit 168, the first clocking unit 169, the second clocking unit 170, the third clocking unit 171, the determination unit 172, the second output unit 173, the stimulus reducing unit 174, and the warning unit 175 of the fatigue recovery assistance unit 160 described in FIG. 2 are executed. Moreover, the storage unit 161 of the fatigue recovery assistance unit 160 is implemented by, for example, the RAM 10c or the auxiliary storage device 10d.

The computer program executed by the driving assistance device 100 according to the present embodiment may be provided by being recorded in a computer-readable recording medium such as a CD-ROM, a flexible disk (FD), a CD-R, or a digital versatile disk (DVD) as a file in an installable format or an executable format. Moreover, the computer program executed by the driving assistance device 100 of the present embodiment may be configured to be stored on a computer connected to a network such as the Internet and provided by being downloaded via the network. Moreover, the computer program executed by the driving assistance device 100 of the present embodiment may be configured to be distributed via a broadcasting system such as terrestrial data broadcasting.

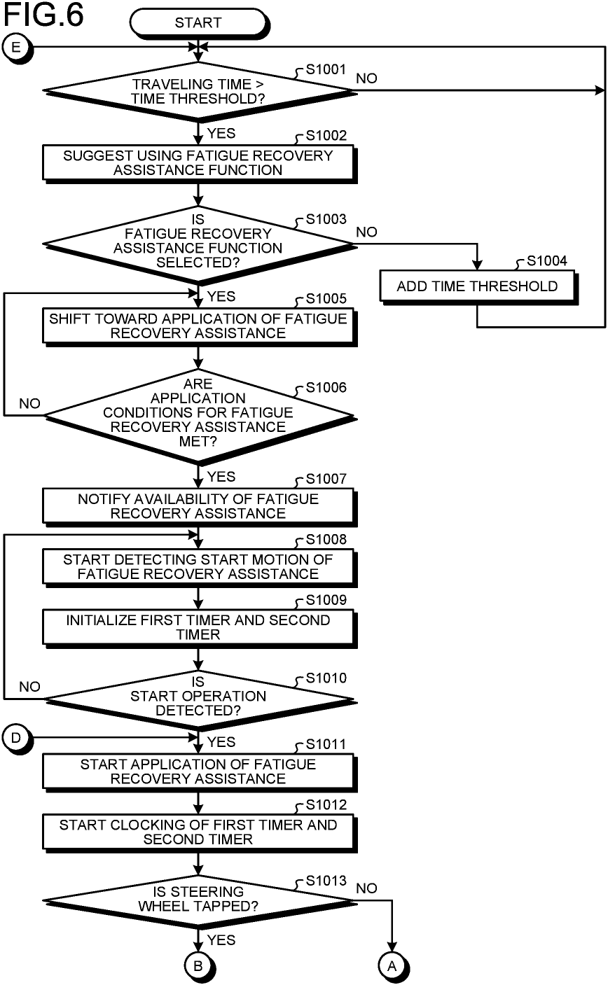

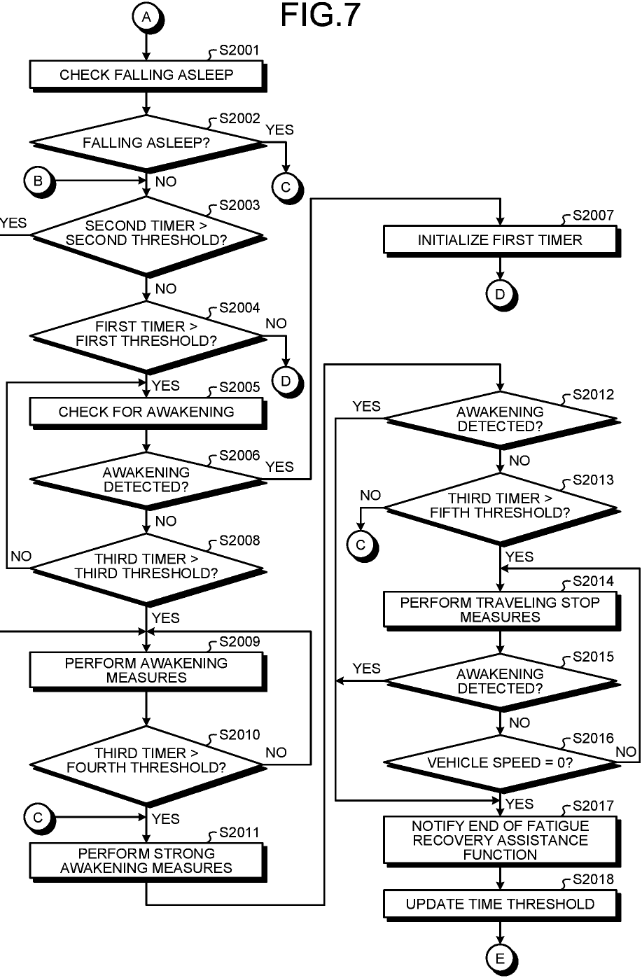

Next, a flow of the fatigue recovery assistance processing executed by the driving assistance device 100 configured as described above will be described with reference to FIGS. 6 and 7. The fatigue recovery assistance function executed in the fatigue recovery assistance processing is an example of a driver assistance function that does not output a predetermined warning to the driver when the driver’s eyes are closed. The processing in FIG. 6 starts when, for example, the vehicle 1 starts the driving monitoring function.

First, the driver monitoring unit 168 determines whether the traveling time during which the driver has traveled within the past 24 hours is larger than a predetermined time threshold (Step S1001). In response to determining that the traveling time is smaller than the time threshold (Step S1001: No), the driver monitoring unit 168 returns to Step S1001 and repeats Step S1001 until the traveling time becomes larger than the time threshold. In response to determining that the traveling time is larger than the time threshold (Step S1001: Yes), the driver monitoring unit 168 proceeds to Step S1002.

Subsequently, the driver monitoring unit 168 suggests a fatigue recovery assistance function (Step S1002). Subsequently, the input unit 163 determines whether or not the fatigue recovery assistance function is selected (Step S1003). The detection that the fatigue recovery assistance function is selected may be detection of operation of a predetermined switch or button, and when the predetermined switch or button is pressed, it may be determined that the first assistance start condition is satisfied.

Moreover, not only the detection of the operation of the switch but also the detection of the utterance of a predetermined voice command, the execution of the automatic steering control in the vehicle 1, the closing of the driver’s eyes, and the driver’s predetermined awakening state may be regarded as an input for selecting the use of the fatigue recovery assistance function, and it may be determined that the first assistance start condition is satisfied. In response to determining that the fatigue recovery assistance function is not selected (Step S1003: No), the input unit 163 proceeds to Step S1004. In response to determining that the fatigue recovery assistance function is selected (Step S1003: Yes), the input unit 163 proceeds to Step S1005.

Subsequently, the driver monitoring unit 168 adds a time threshold (Step S1004). The value to be added is, for example, 30 minutes. After adding the time threshold, the driver monitoring unit 168 returns to Step S1001 and repeats Step S1001 until the traveling time becomes larger than the added time threshold.

Subsequently, in a case where the fatigue recovery assistance function is selected, a determination is made to shift to application of the fatigue recovery assistance function. For example, the driving assistance control unit 167 sets a usage selection flag indicating that the driver has selected the use of the fatigue recovery assistance function, and accordingly, determines a policy of shifting toward the application of the fatigue recovery assistance function (Step S1005).

Since it is necessary that the automatic steering control is executed in the vehicle 1 as an application condition of the fatigue recovery assistance, the automatic steering control may be executed in Step S1005 in a case where the automatic steering control is not executed in the vehicle 1. For example, in a case where the automatic steering control cannot be executed because the vehicle 1 is not on the highway, the driver may be instructed to use the highway as the control for shifting to the application of the fatigue recovery assistance function. Moreover, for example, in a case where the vehicle 1 is performing autonomous driving including automatic steering control and is traveling on a passing lane, the lane may be changed so as to follow a low-speed vehicle on the traveling lane in order to satisfy the second assistance start condition.

Subsequently, the determination unit 172 determines whether the first assistance start condition is satisfied, and the second assistance start condition is satisfied, and the automatic steering control is being executed in the vehicle 1 (Step S1006). In response to determining that the automatic steering control is not executed in the vehicle 1 (Step S1006: No), the determination unit 172 returns to Step S1005. In response to determining that the first assistance start condition is satisfied, and the second assistance start condition is satisfied, and the automatic steering control is being executed in the vehicle 1 (Step S1006: Yes), the determination unit 172 proceeds to Step S1007.

Subsequently, the driving assistance control unit 167 notifies the driver of the availability of the fatigue recovery assistance function (Step S1007). Subsequently, the driver motion detection unit 166 acquires the state of the driver from the acquisition unit 162 (starts detecting the start operation of the fatigue recovery assistance) (Step S1008). The start operation detected here is, for example, a gesture of closing the eyes by the driver. Subsequently, the first clocking unit 169 and the second clocking unit 170 initialize the clocked time (Step S1009).

Subsequently, the determination unit 172 determines whether the first assistance start condition is satisfied, and the second assistance start condition is satisfied, and the automatic steering control is being executed in the vehicle 1, and the start operation of the fatigue recovery assistance is detected (Step S1010). In Step S1003, when the closing gesture of the eyes by the driver is regarded as an input for selecting the use of the fatigue recovery assistance function and a determination that the first assistance start condition is satisfied is made, it can be determined that the start operation of the fatigue recovery assistance is detected also in Step S1010. That is, in a case where the automatic steering control is being executed in the vehicle 1, the driver may use the fatigue recovery assistance function only by closing his/her eyes.

In response to determining that the support start operation is not detected (Step S1010: No), the determination unit 172 returns to Step S1008. In response to determining that the first assistance start condition is satisfied, and the second assistance start condition is satisfied, and the automatic steering control is being executed in the vehicle 1, and the support start operation is detected (Step S1010: Yes), the determination unit 172 proceeds to Step S1011.

Subsequently, the driving assistance control unit 167 starts application of fatigue recovery assistance (Step S1011). Subsequently, the first clocking unit 169 and the second clocking unit 170 start clocking time (Step S1012).

Subsequently, the determination unit 172 determines whether the first assistance start condition is satisfied, and the second assistance start condition is satisfied, and the automatic steering control is being executed in the vehicle 1, and the driver’s eyes are closed, and the driver taps the steering wheel (Step S1013). The tap at this time is an operation for voluntarily notifying the driving assistance control unit 167 that the driver is in the awakening state, and does not correspond to a request from the driving assistance control unit 167. Here, since it is only necessary to confirm that the driver is in the awakening state, for example, in a case where the driver is tapping voluntarily, the driver may not be requested to tap the steering wheel in the subsequent control.

Here, when the driver taps the steering wheel (Step S1013: Yes), the determination unit 172 proceeds to Step S2003. In a case where the driver does not tap the steering wheel (Step S1013: No), the determination unit 172 proceeds to Step S2001.

In a case where the driver does not tap the steering wheel, the driver monitoring unit 168 monitors the state of the eyes of the driver of the vehicle 1 and the awakening state of the driver. For example, the driver monitoring unit 168 checks a falling asleep state of the driver (Step S2001). Subsequently, the determination unit 172 determines whether the driver’s eyes are closed and the driver is falling asleep (that is, determines whether or not the driver is in a predetermined awakening state) (Step S2002).

In response to determining that the driver is falling asleep (that is, he/she is not in the predetermined awakening state) (Step S2002: Yes), the determination unit 172 proceeds to Step S2011. In response to determining that the driver is not falling asleep (that is, he/she is in the predetermined awakening state) (Step S2002: No), the determination unit 172 proceeds to Step S2003.

In a case where the driver taps the steering wheel or in a case where the awakening of the driver is confirmed, the second clocking unit 170 subsequently determines whether the clocked time exceeds the second threshold (Step S2003). The second threshold is an upper limit of the available time of the fatigue recovery assistance function. In response to determining that the clocked time exceeds the second threshold value (Step S2003: Yes), the second clocking unit 170 proceeds to Step S2009. In response to determining that the clocked time does not exceed the second threshold (Step S2003: No), the second clocking unit 170 proceeds to Step S2004.

Subsequently, the first clocking unit 169 determines whether the clocked time exceeds the first threshold (Step S2004). The first threshold is an interval for confirming awakening. In response to determining that the clocked time does not exceed the first threshold (Step S2004: No), the first clocking unit 169 returns to Step S1011. In response to determining that the clocked time exceeds the first threshold (Step S2004: No), the first clocking unit 169 proceeds to Step S2005.

Subsequently, the driver monitoring unit 168 checks the state of the eyes of the driver of the vehicle 1 and the awakening state of the driver (Step S2005). A unit by which the driver monitoring unit 168 confirms the awakening state of the driver may be, for example, detecting an operation of tapping the steering wheel of the driver. Although not illustrated, a message requesting the driver to tap the steering wheel may be output by voice before detecting whether the driver taps the steering wheel.

Moreover, in a case where the driver voluntarily taps before being requested to tap, it is determined that the awakening state of the driver has already been detected, and the tap request may be omitted. In a case where the message requesting the tap is output, for example, in a case where the tap of the steering wheel is not detected within 3 seconds from the output of the message, it may be determined that the awakening of the driver is not detected.

Subsequently, the determination unit 172 determines whether the first assistance start condition is satisfied, and the second assistance start condition is satisfied, and the automatic steering control is being executed in the vehicle 1, and the driver’s eyes are closed, and the driver is in a predetermined awakening state (Step S2006). In response to determining that the driver is not in the predetermined awakening state (for example, the driver is falling asleep.) (Step S2006: No), the determination unit 172 proceeds to Step S2008. In response to determining that the driver is in the predetermined awakening state (for example, the driver is not falling asleep.) (Step S2006: Yes), the determination unit 172 proceeds to Step S2007.

In a case where the driver is in the predetermined awakening state, subsequently, the first clocking unit 169 initializes the clocked time (Step S2007). After initializing the clocked time, the first clocking unit 169 proceeds to Step S1001.

Subsequently, the third clocking unit 171 determines whether the clocked time exceeds a third threshold (Step S2008). The third threshold indicates the end of the period in which the confirmation of the awakening state is continued. In response to determining that the clocked time does not exceed the third threshold (Step S2008: No), the third clocking unit 171 returns to Step S2005 and repeats the processing until the clocked time exceeds the third threshold. Since the awakening state of the driver is confirmed in Step S2005, for example, in a case where a message requesting the tapping of the steering wheel is output by voice for confirmation, the output of the message and the detection of the tapping are repeated. In response to determining that the clocked time exceeds the third threshold value (Step S2008: Yes), the third clocking unit 171 terminates the operation of confirming the awakening state of the driver, and proceeds to Step S2009.

Subsequently, the warning unit 175 outputs a predetermined warning to the driver and applies an awakening stimulus to the body of the driver (Step S2009).

Subsequently, the third clocking unit 171 determines whether the clocked time exceeds the fourth threshold (Step S2010). The fourth threshold indicates the end of the duration of awakening measures. In response to determining that the clocked time does not exceed the fourth threshold (Step S2010: No), the third clocking unit 171 returns to Step S2009 and continues awakening measures. In response to determining that the clocked time exceeds the fourth threshold (Step S2010: Yes), the third clocking unit 171 proceeds to Step S2011.

Subsequently, the warning unit 175 applies, to the driver, a second awakening stimulus that is the same stimulus as the first awakening stimulus and is stronger than the first awakening stimulus (Step S2011). Subsequently, the determination unit 172 determines whether or not the driver is in a predetermined awakening state (Step S2012). In response to determining that the driver is in the predetermined awakening state (for example, the driver is awake) (Step S2012: Yes), the determination unit 172 proceeds to step S2017. In response to determining that the driver is not in the predetermined awakening state (for example, the driver is falling asleep.) (Step S2012: No), the determination unit 172 proceeds to Step S2013.

Subsequently, the third clocking unit 171 determines whether the clocked time exceeds the fifth threshold (Step S2013). The fifth threshold indicates the end of the duration of the intense awakening measures. In response to determining that the clocked time does not exceed the fifth threshold (Step S2013: No), the third clocking unit 171 returns to Step S2011 and continues strong awakening measures. In response to determining that the clocked time exceeds the fifth threshold (Step S2013: Yes), the third clocking unit 171 proceeds to Step S2014.

Subsequently, the warning unit 175 controls the vehicle control unit 180 to decelerate and stop the vehicle 1 and end the autonomous driving control (Step S2014). Subsequently, the determination unit 172 determines whether or not the driver is in a predetermined awakening state (Step S2015). In response to determining that the driver is in the predetermined awakening state (For example, waking up) (Step S2015: Yes), the determination unit 172 proceeds to step S2017. In response to determining that the driver is not in the predetermined awakening state (for example, the driver is falling asleep) (Step S2015: No), the determination unit 172 proceeds to Step S2016.

The vehicle state detection unit 165 determines whether or not the vehicle speed of the vehicle 1 is zero (Step S2016). In response to determining that the vehicle speed of the vehicle 1 is not zero (Step S2016: No), the vehicle state detection unit 165 repeats the processing until the vehicle speed of the vehicle 1 becomes zero. In response to determining that the vehicle speed of the vehicle 1 is zero (Step S2016: Yes), the vehicle state detection unit 165 proceeds to Step S2017.

Subsequently, the driving assistance control unit 167 notifies the driver of the end of the fatigue recovery assistance (Step S2017). Subsequently, the storage unit 161 updates the time threshold (Step S2018). Thereafter, the processing returns to S1001. The processing of this flowchart is continuously executed while the vehicle 1 is traveling.

As described above, the driving assistance device 100 of the present embodiment is a driving assistance device that can be mounted on the vehicle 1 capable of executing the automatic steering control, and includes the driver monitoring unit 168 and the warming unit 175. The driver monitoring unit 168 monitors the state of the eyes of the driver of the vehicle 1 and the awakening state of the driver. The warning unit 175 outputs a warning to the driver. Moreover, the warning unit 175 outputs a predetermined warning to the driver in a case where the automatic steering control is being executed in the vehicle 1, and the driver’s eyes are closed, and the driver is not in a predetermined awakening state. Moreover, the warning unit 175 does not output a predetermined warning to the driver in a case where the automatic steering control is being executed in the vehicle 1, and the driver’s eyes are closed, and the driver is in a predetermined awakening state.

According to the configuration of the present embodiment described above, since the driving assistance device 100 executes whether or not to output the warning according to the awakening state of the driver during the automatic steering control, for example, in a case where the driver is awakened, the driver can recover from fatigue.

In the embodiment described above, after the driving assistance control unit 167 notifies the driver of the availability of the fatigue recovery assistance function (for example, Step S1007), a state in which the automatic steering control is not executed in the vehicle 1 may occur. In a first modification example, a case where a state in which the automatic steering control is not executed occurs in the vehicle 1 will be described.

### First Modification Example

For example, after the driving assistance control unit 167 notifies the driver of the availability of the fatigue recovery assistance function (for example, Step S1007), a state in which the automatic steering control is not executed in the vehicle 1 may occur. The state in which the automatic steering control is not executed in the vehicle 1 may include, for example, detection of another approaching vehicle, interruption in front of the vehicle 1, approach to a divergence point (when the divergence cannot be performed by the automatic steering control), approach to an end position of a use section of an expressway, and the like. Since the use of the fatigue recovery assistance function is on the basis of the premise that the automatic steering control is executed in the vehicle 1, when the automatic steering control is stopped, the use of the fatigue recovery assistance function also needs to be stopped. Since the driver using the fatigue recovery assistance function closes his/her eyes, it is necessary to urge the driver to open his/her eyes.

When the automatic steering control is not executed in the vehicle 1, the driving assistance control unit 167 may, for example, forcibly cause the warning unit 175 to apply an awakening stimulus to the body of the driver (Step S2009). For example, the processing may be branched from the step between Step S1007 and Step S1008 to transition to Step S2009. Specifically, the navigation device 29 may perform the interruption processing when the own position on the route of the vehicle 1 is in a state where the automatic steering control is not executed in the vehicle 1. Moreover, when the distance measuring device 151 detects approach of an object around vehicle 1 on the basis of a result of transmission and reception of a sound wave or an electromagnetic wave by the transmitter/receiver 15, processing of interrupting may be performed.

Note that in steps prior to Step S1007, the use of the fatigue recovery assistance function has not started, and thus the interrupting process may not be performed. Moreover, in a case where the driver opens the eyes while using the fatigue recovery assistance function, it is determined that the driver has instructed to stop the fatigue recovery assistance, and the process may be immediately branched to Step S2017 to notify the end of the fatigue recovery assistance function, or a step of selecting the stop of the fatigue recovery assistance or making an inquiry to the driver may be inserted.

In the embodiment described above, the mode in which the driver motion detection unit 166 confirms awakening by detecting the tap movement of the driver has been described. In a second modification example, a mode in which the driver motion detection unit 166 detects the awakening level of the driver from the image of the face of the driver will be described.

### Second Modification Example

In a case where the driving assistance control unit 167 is performing the fatigue recovery assistance, if the driver is weak with his/her eyes closed, there is a possibility that the driver shifts to dozing (loss of awakening or falling asleep). By detecting the steering wheel operation force operated by the driver, the driver motion detection unit 166 can detect a state when the driver is not dozing, but by providing another unit for detecting dozing, safety can be further increased.

For example, the driver motion detection unit 166 detects the opening of the driver’s mouth, that is, the open state. Specifically, when the driver places his/her head on the headrest from the driving posture, the lower jaw of the driver is pulled from below by gravity and the anterior cervical muscle. However, if the masseter muscle (closing muscle) is tense (for example, in the awakening state), the mouth is not opened. However, since the mouth opens when the masseter becomes loose after falling asleep, the awakening state can be detected from the opening state of the driver.

Moreover, the driver motion detection unit 166 may detect the opening state of the driver using a face recognition technology. The mouth is one of parts of an eye, a nose, and a mouth arranged in a T shape in a human face, and a mouth portion can be extracted according to a position on a face image. At this time, the position and angle of the nose part are small in the amount of change due to the facial expression lines and are not hidden by the hair, and thus are suitable as a reference for specifying the position and direction of other face parts. When the brightness of the central portion of the mouth image is scanned in the vertical direction, the driver motion detection unit 166 can detect the opening state of the driver because there is a large brightness change when the mouth is open, whereas there is a small brightness change when the mouth is closed.

Moreover, on the basis of the eyelid image, the driver motion detection unit 166 may detect that the driver has shifted from the state of closing the eyes by intention to sleep. When a person consciously closes his/her eyes, a feature appears in an image of parts of the eyes (including eyebrows), such as wrinkles on the eyelids or eyebrows lowering. When a person shifts to sleep, the muscles around the eyelids and eyes become weak, and changes such as the wrinkles of the eyelids disappear and the eyebrows rise (the distance from the nose part increases) appear.

When the brightness of the central portion of the image of the eye parts (including the eyebrows) is scanned in the vertical direction, the driver motion detection unit 166 can detect the eyelid wrinkle as the vertical movement of the brightness. Therefore, when the vertical movement of the brightness (the eyelid wrinkle) disappears, the driver’s shift to sleep can be detected.

Moreover, the driver motion detection unit 166 may detect the movement of the eyeball. Since the pupil portion of the eyeball bulges, the movement of the eyeball can be captured through the eyelid even if the eyelid is closed. While the driver follows an object outside the vehicle with his/her eyes, the eyeballs move busily, and involuntary fibrillation often continues even when the eyes are closed. It is generally known that sleep is divided into REM sleep accompanied by Rapid Eye Movement and non-REM sleep not accompanied by Rapid Eye Movement, and when falling asleep, the sleep enters the non-REM sleep without going through the REM sleep. That is, when a person is falling asleep, the eye movement stops.

Non-REM sleep is a so-called fast sleep state, and does not wake up even when making some noise or being slightly shaken. When forcibly woken up during non-REM sleep, a person cannot immediately start an activity. A person is required to have some time until the cerebrum starts an activity from the resting state, and even if the person is woken up, the person is in a “vanishing love” state in which the person cannot consciously move to the next action for a while.

Even when the driver does not have to gaze forward during autonomous driving, the driver is required to immediately drive when the autonomous driving is stopped for some reason. Since the sleep gradually shifts to the non-REM sleep when the awakening state starts to fall asleep, in the embodiment of the present invention, the awakening measures are performed when the awakening state cannot be confirmed. Moreover, in a case where the subject does not immediately wake up even if the awakening measures are performed, or in a case where a sign of non-REM sleep is observed, the traveling stop measure may be always executed.

While certain embodiments have been described, these embodiments have been presented by way of example only, and are not intended to limit the scope of the inventions. Indeed, the novel methods and systems described herein may be embodied in a variety of other forms; moreover, various omissions, substitutions and changes in the form of the methods and systems described herein may be made without departing from the spirit of the inventions. The accompanying claims and their equivalents are intended to cover such forms or modifications as would fall within the scope and spirit of the inventions.

The driving assistance device according to the present disclosure enables the driver to recover from fatigue.

What is claimed is:

1. A driving assistance device to be mounted on a vehicle capable of executing automatic steering control, the driving assistance device comprising
a hardware processor connected to a memory, the hardware processor being configured to:
monitor a state of eyes of a driver of the vehicle and an awakening state of the driver;
output a predetermined warning to the driver in a case where
the automatic steering control is being executed in the vehicle,
the eyes of the driver are closed, and
the driver is not in a predetermined awakening state; and
output none of the predetermined warning to the driver in a case where
the automatic steering control is being executed in the vehicle,
the eyes of the driver are closed, and
the driver is in the predetermined awakening state.

2. The driving assistance device according to claim 1, wherein the hardware processor is configured to:
output the predetermined warning to the driver in a case where
the automatic steering control of the vehicle is not being executed, and
the eyes of the driver are closed; and
output none of the predetermined warning to the driver in a case where the eyes of the driver are open.

3. The driving assistance device according to claim 1, wherein the hardware processor is configured to:
output a predetermined warning to the driver in a case where
the automatic steering control is being executed in the vehicle,
the eyes of the driver are continuously closed for a first time or more, and
the driver is not in a predetermined awakening state; and
output the predetermined warning to the driver in a case where
the automatic steering control is executed in the vehicle,
the eyes of the driver are continuously closed for a second time or more, and
the driver is in the predetermined awakening state.

4. The driving assistance device according to claim 3, wherein the first time is shorter than the second time.

5. The driving assistance device according to claim 1, wherein the hardware processor is configured to:
output a predetermined warning to the driver in a case where
an assistance start condition is satisfied, the assistance start condition including at least one condition of: receiving an instruction to switch to the automatic steering control, detecting an eye closing operation performed by the driver, detecting a head of the driver touching a headrest of the vehicle, detecting a foot being placed on a footrest of the vehicle, detecting a foot being placed on a brake pedal of the vehicle, detecting a hand being placed on an armrest of the vehicle, detecting utterance of a predetermined keyword, and detecting an operation of a predetermined button or switch,
the automatic steering control is being executed in the vehicle,
the eyes of the driver are closed, and
the driver is not in a predetermined awakening state,
output none of the predetermined warning to the driver in a case where
the assistance start condition is satisfied,
the automatic steering control is being executed in the vehicle,
the eyes of the driver are closed, and
the driver is in the predetermined awakening state.

6. The driving assistance device according to claim 5, wherein the hardware processor is configured to:
set the assistance start condition as a first assistance start condition;
output a predetermined warning to the driver in a case where
the first assistance start condition is satisfied,
a second assistance start condition is satisfied, the second assistance start condition including at least one condition of: detecting the vehicle being in a cruising traveling state in which the vehicle travels at a cruising speed, detecting the vehicle being in a follow-up traveling state in which the vehicle follows a preceding vehicle, and detecting the vehicle being in a congested traveling state in which an average speed of the vehicle is less than or equal to a predetermined threshold,
the automatic steering control is being executed in the vehicle,
the eyes of the driver are closed, and
the driver is not in a predetermined awakening state; and
output none of the predetermined warning to the driver in a case where
the first assistance start condition is satisfied,
the second assistance start condition is satisfied,
the automatic steering control is being executed in the vehicle,
the eyes of the driver are closed, and
the driver is in the predetermined awakening state.

7. The driving assistance device according to claim 1, wherein
the hardware processor is configured to perform a predetermined stimulus reduction on the driver in a case where
the automatic steering control is being executed in the vehicle,
the eyes of the driver are closed, and
the driver is in the predetermined awakening state, and
the predetermined stimulus reduction includes at least one of actions of: reducing vibration received by the driver, reducing acceleration received by the driver, notifying the driver of a behavior of the vehicle in a case where the driver receives acceleration due to a behavior of the vehicle, reducing sound entering ears of the driver, reducing light stimulus entering eyes of the driver, reducing a seat pressure received by buttocks of the driver, and reducing a pressure received by the driver from a seat belt.

8. The driving assistance device according to claim 1, wherein the hardware processor is configured to
apply an inquiry stimulus to the driver, and
determine an awakening state of the driver on the basis of a predetermined response determination condition, the predetermined response determination condition including at least one of: presence or absence of a response of the driver to the inquiry stimulus, a strength of a response of the driver to the inquiry stimulus, and a response time until a response to the inquiry stimulus is made.

9. The driving assistance device according to claim 8, wherein
the inquiry stimulus applied to the driver includes at least one of a light ray stimulus, a tactile stimulus, and a voice, and
the inquiry stimulus is a stimulus weaker than a warning given to the driver.

10. The driving assistance device according to claim 8, wherein the hardware processor is configured to intensify the inquiry stimulus in a case where a response of the driver to the inquiry stimulus does not satisfy a predetermined condition.

11. The driving assistance device according to claim 1, wherein the hardware processor is configured, in a case where the driver is not in a predetermined awakening state, to output a predetermined warning to the driver and apply an awakening stimulus to a body of the driver.

12. The driving assistance device according to claim 11, wherein the awakening stimulus includes at least one of: a tactile stimulus by at least one of a seat of the vehicle, an armrest of the vehicle, a footrest of the vehicle, a headrest of the vehicle, a steering wheel of the vehicle, a pedal of the vehicle, and a seat belt of the vehicle, an acceleration stimulus under control of a speed reducer or a steering angle controller, an auditory stimulus by a sound emitted by the vehicle, and a light ray stimulus to an eyelid of a driver.

13. The driving assistance device according to claim 11, wherein the hardware processor is configured to:
set the awakening stimulus as a first awakening stimulus;
output the predetermined warning to the driver and apply the first awakening stimulus to the driver in a case where the driver is not in a predetermined awakening state; and
perform, in a case where the driver does not shift to an awakening state within a predetermined time after the first awakening stimulus is applied, at least one of actions of applying the driver a second awakening stimulus being stronger than the first awakening stimulus, decelerating or stopping the vehicle, and ending autonomous driving control is executed.

14. The driving assistance device according to claim 1, wherein the hardware processor is configured to receive an input for selecting use of a driver assistance function, the driver assistance function being a function to output none of the predetermined warning to the driver in a case where the driver is in the predetermined awakening state while the automatic steering control is being executed in the vehicle and the eyes of the driver are closed.

15. The driving assistance device according to claim 14, wherein the hardware processor is configured to perform control to create a state suitable for use of the driving assistance function in a case where the input for selecting use of the driving assistance function is received and a current state is not the state suitable for use of the driving assistance function.

16. The driving assistance device according to claim 15, wherein the control to create a state suitable for use of the driving assistance function includes
notifying a driver of at least one of
guidance to a road of a type suitable for autonomous driving control, suggestion of switching to the autonomous driving control, guidance to a position following a preceding vehicle suitable for follow-up traveling, and guidance to a lane suitable for use of the driver assistance function, or
at least one of actions of
movement to a road of a type suitable for autonomous driving control, switching to the autonomous driving control, movement to a position following a preceding vehicle suitable for follow-up traveling, and movement to a lane suitable for use of the driver assistance function.

17. The driving assistance device according to claim 15, wherein the hardware processor is configured to apply the driving assistance function in a case where the current state becomes the state suitable for use of the driving assistance function after performing the control to create a state suitable for use of the driving assistance function.

18. The driving assistance device according to claim 14, wherein the hardware processor is configured to output, to the driver, a suggestion of use of the driver assistance function to output none of the predetermined warning to the driver, the suggestion being output in a case where
the automatic steering control is being executed in the vehicle,
the eyes of the driver are closed, and
the driver is in the predetermined awakening state.

19. The driving assistance device according to claim 18, wherein the hardware processor is configured to output the suggestion of use of the driver assistance function, on the basis of at least one of a behavior state of the driver, a behavior history including the behavior state of the driver, and a determination on whether or not the current state is a state suitable for the driver assistance function.

20. The driving assistance device according to claim 19, wherein the behavior state includes at least one of
fatigue information indicating a fatigue state of the driver,
driving time information indicating a time during which the driver drives the vehicle, and
eating and drinking time information indicating a time during which the driver eats and drinks.
